(19) United States
(12) Patent Application Publication
(10) Pub. No.: US 2025/0377689 A1
(43) Pub. Date: Dec. 11, 2025

(54) PROTECTIVE CASE

(71) Applicant: RAKUTEN KOBO INC., Toronto (CA)

(72) Inventors: Archer WUN, Toronto (CA); Anna BUECHIN, Toronto (CA); KuanChang LIN, New Taipei City (TW); CheYu LIN, Zhubei City (TW); Tong Yun SIAO, Hsinchu City (TW)

(73) Assignee: RAKUTEN KOBO INC., Toronto (CA)

(21) Appl. No.: 19/175,394

(22) Filed: Apr. 10, 2025

Related U.S. Application Data
(60) Provisional application No. 63/658,676, filed on Jun. 11, 2024.

(51) Int. Cl. G06F 1/16; G06F 1/18

(52) U.S. Cl. CPC G06F 1/1607; G06F 1/189

(57) ABSTRACT

Some implementations may include a protective case for an electronic device. The protective case may include a front cover, a rear cover, and a hinge, operatively connecting the front cover to the rear cover, defining a hinge axis. The front cover may be movable, relative to the rear cover and about the hinge axis, between a closed position and an open position. The rear cover may include a first sidewall, aligned along the hinge axis, and a second sidewall, aligned at an angle relative to the first sidewall, that are configured to releasably retain the electronic device. The rear cover may include a storage compartment, positioned adjacent to the first sidewall, configured to detachably store a stylus associated with the electronic device.

### CROSS-REFERENCE TO RELATED APPLICATIONS

This application claims the benefit of U.S. Provisional Application No. 63/658,676, filed Jun. 11, 2024, which is incorporated herein by reference in its entirety.

### BACKGROUND

Protective cases are utilized to shield electronic devices from various types of damage. For example, protective cases are typically designed to protect both housings and sensitive components of the electronic devices, such as screens and interfaces, from impacts, scratches, and exposure to environmental factors (e.g., dust and moisture).

### SUMMARY

Some implementations described herein relate to a protective case for an electronic device, comprising: a front cover; a rear cover; and a hinge, operatively connecting the front cover to the rear cover, defining a hinge axis, wherein the front cover is movable, relative to the rear cover and about the hinge axis, between a closed position and an open position, wherein the rear cover includes a sidewall, aligned along the hinge axis, and an second sidewall, aligned at an angle relative to the sidewall, that are configured to releasably retain the electronic device, and wherein rear cover includes a storage compartment, positioned adjacent to the sidewall, configured to detachably store a stylus associated with the electronic device.

A system, comprising: an electronic device; and a protective case, the protective case including: a front cover; a rear cover; and a hinge, operatively connecting the front cover to the rear cover, defining a hinge axis, wherein the front cover is movable, relative to the rear cover and about the hinge axis, between a closed position and an open position, wherein the rear cover includes a sidewall, aligned along the hinge axis, and an second sidewall, aligned at an angle relative to the sidewall, that are configured to releasably retain the electronic device, and wherein rear cover includes a storage compartment, positioned adjacent to the sidewall, configured to detachably store a stylus associated with the electronic device.

### BRIEF DESCRIPTION OF THE DRAWINGS

FIG. 1 is a perspective view of an example protective case for an electronic device with the protective device in an open position.

FIG. 2 is a bottom view of the protective case of FIG. 1.

FIG. 3 is a top view of the protective case of FIG. 1.

FIG. 4 is a left view of the protective case of FIG. 1.

FIG. 5 is a right view of the protective case of FIG. 1.

FIG. 6 is a front view of the protective case of FIG. 1.

FIG. 7 is a rear view of the protective case of FIG. 1.

FIG. 8 is a perspective view of the protective case of FIG. 1 with the protective case in a closed position.

FIG. 9 is a cross section taken along line 9-9 of FIG. 6.

FIG. 10 is a perspective view of another example protective case.

FIG. 11 is a bottom view of the protective case of FIG. 10.

FIG. 12 is a top view of the protective case of FIG. 10.

FIG. 13 is a left view of the protective case of FIG. 10.

FIG. 14 is a right view of the protective case of FIG. 10.

FIG. 15 is a front view of the protective case of FIG. 10.

FIG. 16 is a rear view of the protective case of FIG. 10.

FIG. 17 is a perspective view of the protective case of FIG. 10 with the protective case in a closed position.

FIG. 18 is a cross section taken along line 18-18 of FIG. 15.

FIG. 19 is a perspective view of the protective case of FIG. 10 in an example stand position.

FIG. 20 is a front perspective view of a protective case, with the protective case in an open position.

FIG. 21 is a bottom plan view of the protective case of FIG. 20.

FIG. 22 is a top plan view of the protective case of FIG. 20.

FIG. 23 is a left elevation view of the protective case of FIG. 20.

FIG. 24 is a right elevation of the protective case of FIG. 20.

FIG. 25 is a front plan view of the protective case of FIG. 20.

FIG. 26 is a rear plan view of the protective case of FIG. 20.

FIG. 27 is a front perspective view of the protective case of FIG. 20 in a closed position.

FIG. 28 is a cross section taken along line 28-28 of FIG. 25.

FIG. 29 is a front perspective view of a protective case, with the protective case in an open position.

FIG. 30 is a bottom plan view of the protective case of FIG. 29.

FIG. 31 is a top plan view of the protective case of FIG. 29.

FIG. 32 is a left elevation view of the protective case of FIG. 29.

FIG. 33 is a right elevation view of the protective case of FIG. 29.

FIG. 34 is a front plan view of the protective case of FIG. 29.

FIG. 35 is a rear plan view of the protective case of FIG. 29.

FIG. 36 is a front perspective view of the protective case of FIG. 29 in a closed position.

FIG. 37 is a cross section taken along line 37-36 of FIG. 34.

FIG. 38 is a rear perspective view of the protective case of FIG. 29 in a stand position.

FIG. 39 is a front perspective view of a protective case.

FIG. 40 is a front plan view of the protective case of FIG. 39.

FIG. 41 is a rear plan view of the protective case of FIG. 39.

FIG. 42 is a left elevation view of the protective case of FIG. 39.

FIG. 43 is a right elevation view of the protective case of FIG. 39.

FIG. 44 is a top elevation view of the protective case of FIG. 39.

FIG. 45 is a bottom elevation view of the protective case of FIG. 39.

FIG. 46 is a cross section taken along line 46-46 of FIG. 40.

FIG. 47 is a cross section taken along line 47-47 of FIG. 40.

FIG. 48 is a front perspective view of a protective case.

FIG. 49 is a front plan view of the protective case of FIG. 48.

FIG. 50 is a rear plan view of the protective case of FIG. 48.

FIG. 51 is a left elevation view of the protective case of FIG. 48.

FIG. 52 is a right elevation view of the protective case of FIG. 48.

FIG. 53 is a top elevation view of the protective case of FIG. 48.

FIG. 54 is a bottom elevation view of the protective case of FIG. 48.

FIG. 55 is a cross section taken along line 55-55 of FIG. 49.

FIG. 56 is a cross section taken along line 56-56 of FIG. 49.

FIG. 57 is a diagram of an example electronic device and an example stylus associated with the electronic device.

### DETAILED DESCRIPTION OF EXAMPLE EMBODIMENTS

The following detailed description of example embodiments refers to the accompanying drawings. The same reference numbers in different drawings may identify the same or similar elements.

Protective cases for electronic devices are used to enhance functionality and provide protection against damage during various activities, such as reading electronic books (e-books) and/or interacting with digital content (e.g., via annotating or highlighting). Typically, an electronic device includes a touchscreen panel attached to a body of the electronic device, allowing users to view and/or interact with digital content. For hands-free operation, users often need to position the electronic device at an inclined or upright angle on a stable surface (e.g., a desk or a table) to maintain comfort and reduce eye strain. However, electronic devices typically lack built-in support stands, making it difficult to achieve an ergonomic viewing angle without additional accessories.

To address this, users frequently turn to external accessories, such as protective cases with integrated stands, to hold the electronic devices in a desired position. However, typical protective cases with integrated stands are associated with various issues and challenges. For example, protective cases with integrated stands face issues related to stability and durability (e.g., lightweight materials used in their construction lose rigidity or wear out over time, leading to instability that risks damaging the electronic devices).

Another challenge associated with protective cases with integrated stands relates to compatibility (e.g., the protective cases with integrated stands are designed for specific models of electronic device, requiring users to purchase new accessories when upgrading or switching devices). This limits versatility and increases costs. Additionally, protective cases with integrated stands often add bulk and weight, reducing the portability and convenience of the electronic device.

Stylus storage presents further challenges for protective cases. For example, typical protective cases lack a dedicated stylus storage area, increasing a risk of misplacement or loss, which can be inconvenient and costly for users who depend on the stylus for tasks, such as annotating and/or highlighting. This also disrupts workflows as users must retrieve the stylus from external locations, decreasing productivity.

Protective cases with integrated stylus storage also have drawbacks. For example, such protective cases have design configurations that fail to securely hold the stylus and/or that position the stylus storage area in inconvenient locations. This can lead to loss of the stylus and/or problems accessing the stylus storage area, causing inconvenience and additional costs for users.

Additionally, inadequate protection within the stylus storage area exposes the stylus to potential damage, such as impact damage during transport or regular use. This can render the stylus unusable, further frustrating users and increasing replacement costs. Furthermore, compatibility issues also arise with stylus storage. Many protective cases are designed to accommodate only specific stylus models, often those produced by a same manufacturer of the electronic device. This design limitation leaves users who rely on non-standard or third-party styluses without a secure storage option, reducing an overall functionality of the protective cases and user satisfaction.

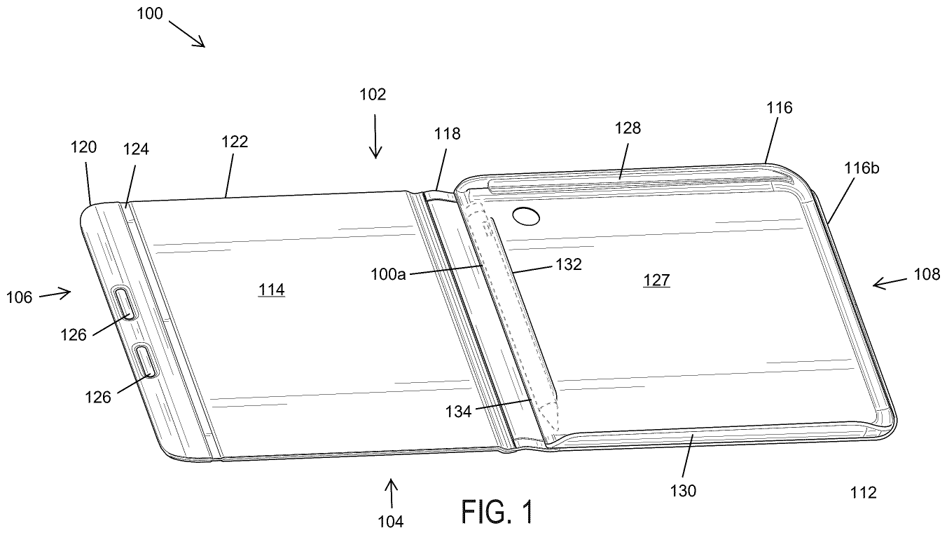

FIGS. 1-9 are diagrams of an example protective case 100, as described in more detail elsewhere herein. In some implementations, the protective case 100 may be configured to protect an electronic device (e.g., an electronic reader (e-reader) device, among other examples) and/or a stylus (e.g., shown as a stylus 100a in FIG. 1) associated with the electronic device. The protective case 100 may be associated with a closed position (e.g., for protecting a front surface of the electronic device) and an open position (e.g., for enabling access to the front surface of the electronic device), as described in more detail elsewhere herein.

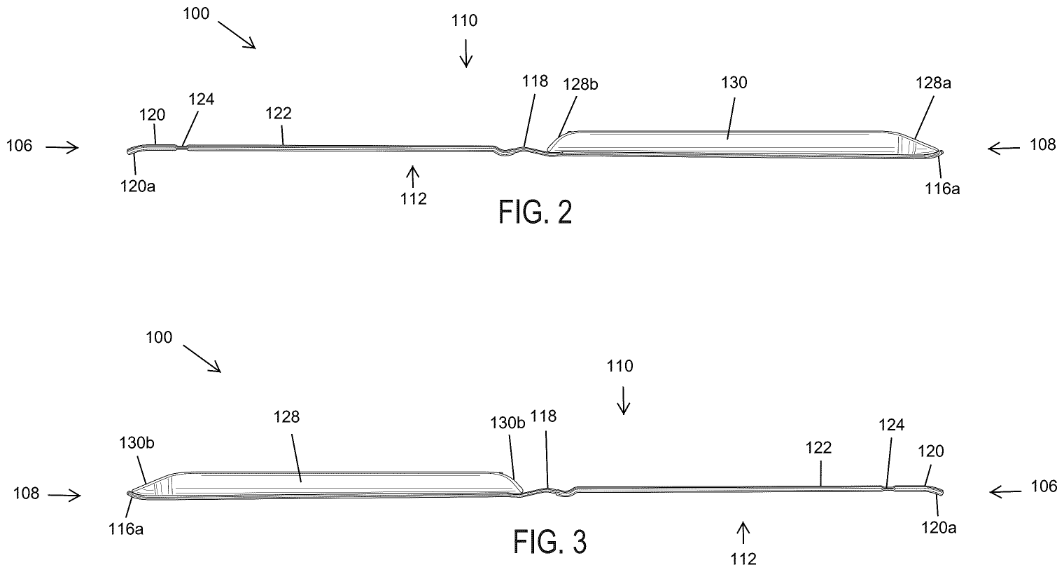

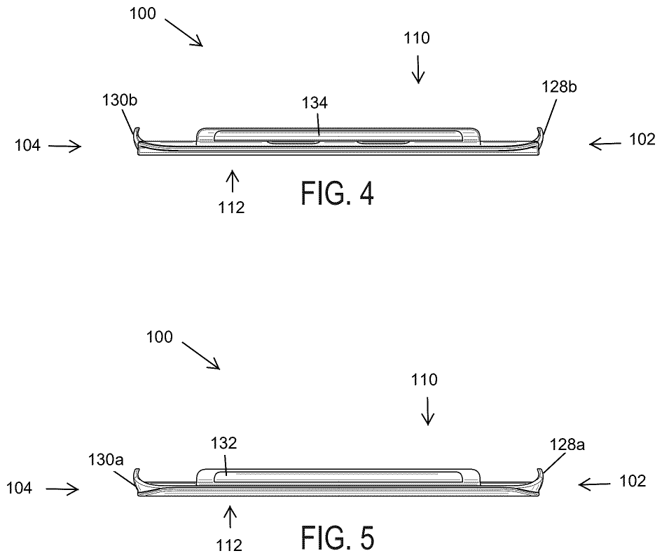

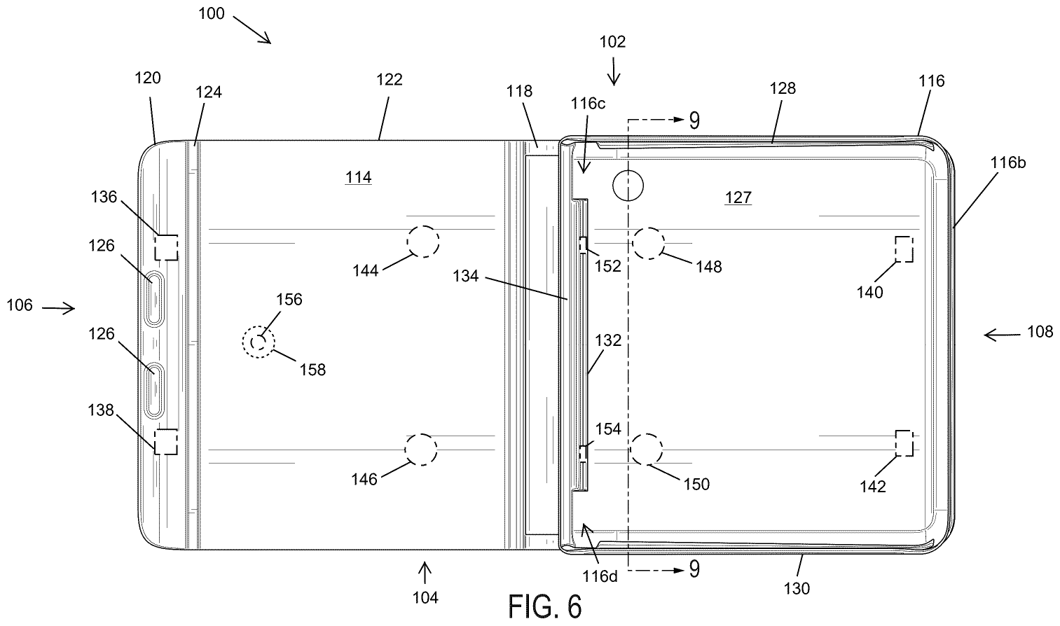

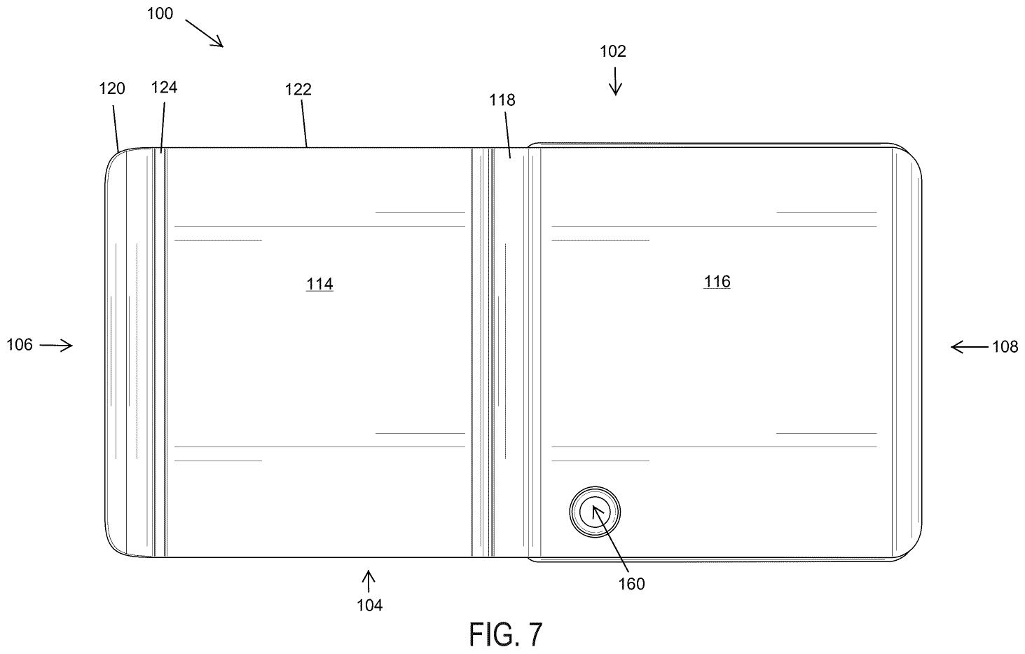

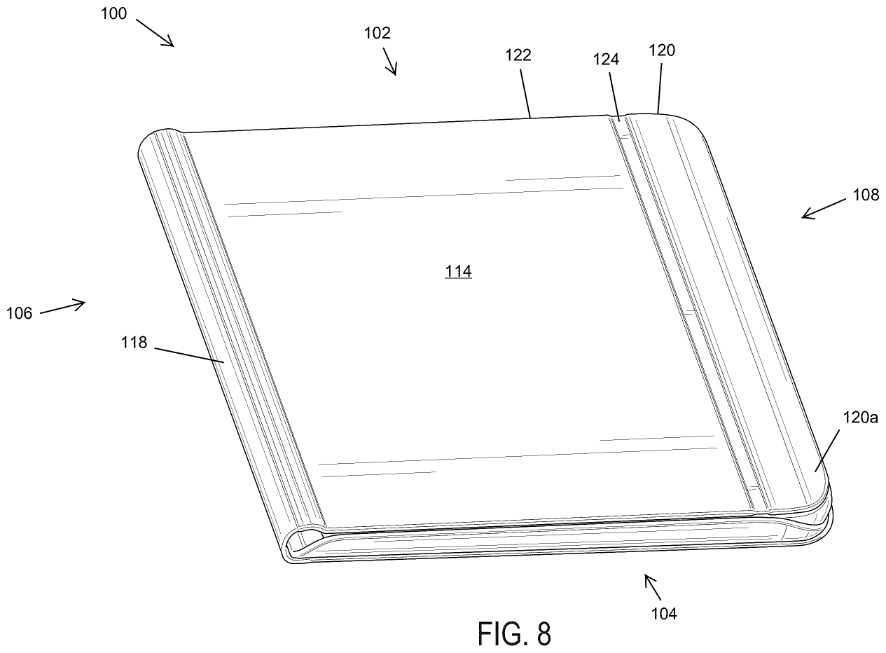

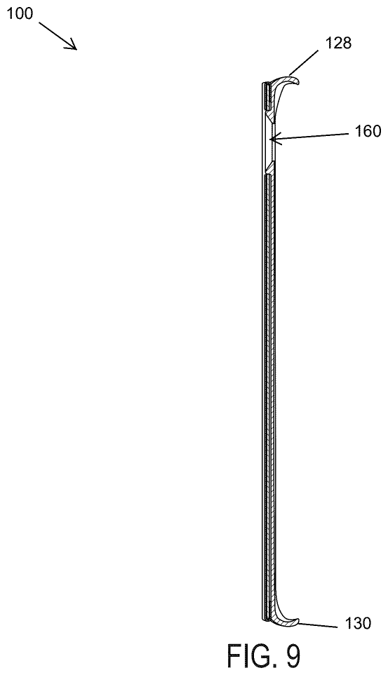

FIGS. 1-7 are diagrams of the protective case 100 in the open position (e.g., FIG. 1 is a perspective view, FIG. 2 is a bottom view, FIG. 3 is a top view, FIG. 4 is a left view, or a first side view, FIG. 5 is a right view, or a second side view, FIG. 6 is a front view, and FIG. 7 a rear view of the protective case 100 in the open position). FIG. 8 is a perspective view of the protective case 100 in the closed position. FIG. 9 is a cross section taken along line 9-9 of FIG. 6.

As shown in FIGS. 1-9, the protective case 100 includes a top 102, a bottom 104, a first side (e.g., shown as a left side 106), a second side (e.g. shown as a right side 108), a front 110, a rear 112, a front cover 114, a rear cover 116, and a hinge (e.g., shown as a folding hinge 118) that operatively couples the front cover 114 to the rear cover 116. The folding hinge 118 may define a hinge axis that enables movement of the front cover 114 relative to the rear cover 116, as described in more detail elsewhere herein. In some implementations, the folding hinge 118 may be a soft spine without a substrate. Although the hinge is described and shown as being a folding hinge in connection with FIGS. 1-9, the hinge may be any suitable mechanism allowing movement of the front cover 114 relative to the rear cover 116.

The front cover 114 may be movable between the closed position (e.g., corresponding to a fully closed position) and the open position (e.g., corresponding to a fully open position). When the front cover 114 is in the closed position (e.g., as shown in FIG. 8), the front cover 114 overlies and protects a front surface (e.g., a touchscreen) of the electronic device.

In some implementations, the front cover 114 may be movable into multiple open positions, such as a first open position or a second open position, that expose the front surface of the electronic device. As an example, and when the front cover 114 is in the first open position, the front cover 114 and the rear cover 116 may be positioned laterally adjacent to one another (e.g., as shown in FIGS. 1-7). As another example, and when the front cover 114 is in the second open position, an exterior surface of the front cover 114 may be in contact with an exterior surface of the rear cover 116.

In some implementations, the front cover 114 may include a first portion 120, a second portion 122, and a pivot mechanism (e.g., shown as a fold line 124). The fold line 124 may be provided between the first portion 120 and the second portion 122 (e.g., the fold line 124 may be integrated into the front cover 114 separating the first portion 120 from the second portion 122) to enable movement of the first portion 120 relative to the second portion 122. In other words, the fold line 124 may divide the front cover 114 into the first portion 120 and the second portion 122 and may define a fold line axis about which the first portion 120 is movable relative to the second portion 122. In some implementations, the first portion 120 may be smaller than the second portion 122 (e.g., a surface area of the first portion 120 may be less than a surface area of the second portion 122).

In some implementations, the movement of the first portion 120 relative to the second portion 122 enables easier opening of the front cover 114, as described in more detail elsewhere herein. For example, the first portion 120 may be movable between a lowered position and a gripping position. When the first portion 120 is in the lowered position, an interior surface of the first portion 120 overlies and protects a portion of the front surface of the electronic device. To move from the lowered position to the gripping position, the first portion 120 may pivot about the fold line axis such that the interior surface of the first portion 120 moves in a direction that is away from the portion of the front surface of the electronic device into the gripping position (e.g., a user may grasp the first portion 120 and cause the first portion 120 to pivot about the fold line axis).

Moving the first portion 120 from the lowered position to the gripping position enables easier opening of the front cover 114 (e.g., because the interior surface of the first portion 120 is not in contact with the front surface of the electronic device, the user may easily grasp an exterior surface of the first portion 120 and the interior surface of the first portion 120 to move the front cover 114 from the closed position to the first open position).

In some implementations, the first portion 120 may include a curved surface (e.g., shown as a curved peripheral surface 120a in FIGS. 2-3, and FIG. 8) that is positioned proximate an outer edge of the first portion 120. The curved peripheral surface 120a may conform to a curved surface of the electronic device. The curved surface may define recesses (e.g., shown as recesses 126 in FIG. 1 and FIG. 6). The recesses 126 may be configured to receive components of the electronic device, such as buttons provided on the front surface of the electronic device, among other examples.

In some implementations, the rear cover 116 may be configured to releasably retain the electronic device. For example, the rear cover 116 may include a retaining portion configured to releasably retain the electronic device, as described in more detail elsewhere herein.

In some implementations, the retaining portion may be formed as a tray including an interior surface 127, a top sidewall 128, a bottom sidewall 130, a lateral sidewall 132, and a storage compartment 134. For example, the tray may be formed from a polymer and/or a polymer-based material through an injection molding process with the tray including (e.g., integrally including) the interior surface 127, the top sidewall 128, the bottom sidewall 130, the lateral sidewall 132, and the storage compartment 134 (e.g., the interior surface 127 may transition into the top sidewall 128, the bottom sidewall 130, the lateral sidewall 132 and the storage compartment 134).

The top sidewall 128 may extend along and adjacent to the top 102 of the protective case 100. The bottom sidewall 130 may extend along and adjacent to the bottom 104 of the protective case 100. The lateral sidewall 132 and the storage compartment 134 may extend along and adjacent to at least a portion of a length of the folding hinge 118 (e.g., the storage compartment 134 may transition into the lateral sidewall 132) of the protective case 100 (e.g., the storage compartment 134 may be provided between the lateral sidewall 132 and the folding hinge 118 and aligned with the hinge axis). Because the storage compartment 134 transitions into the lateral sidewall 132, gaps (e.g., shown as gaps 116c and 116d in FIG. 6) may be defined between the top sidewall 128 and the lateral sidewall 132 and between the bottom sidewall 130 and the lateral sidewall 132. The gaps 116c and 116d enable easier access to the stylus 100a (e.g., when detachably storing the stylus 100a in the storage compartment 134 and/or when removing the stylus 100a from the storage compartment 134, as described in more detail elsewhere herein).

In some implementations, the lateral sidewall 132 and the storage compartment 134 may be aligned with the hinge axis (e.g., the lateral sidewall 132 and the storage compartment 134 may extend in a direction that is substantially parallel to the hinge axis), and the top sidewall 128 and/or the bottom sidewall 130 may be aligned at an angle (e.g., a non-parallel angle) relative to the hinge axis (e.g., the top sidewall 128 and/or the bottom sidewall 130 may extend perpendicularly to the lateral sidewall 132 and the storage compartment 134, among other examples).

In some implementations, the top sidewall 128, the bottom sidewall 130, and the storage compartment 134 may include curved or rounded surfaces (e.g., the curved or rounded surfaces may have partially circular cross sections, among other examples), and the lateral sidewall 132 may include a flat surface. The curved or rounded surfaces of the top sidewall 128 and the bottom sidewall 130 may be configured to releasably retain the electronic device (e.g., via a frictional interface connection between the top sidewall 128 and the electronic device and between the bottom sidewall 130 and the electronic device). The curved or rounded surface of the storage compartment 134 may be configured to receive the stylus 100a (e.g., the curved or rounded surface may match a contour of the stylus 100a). The folding hinge 118 may be configured to at least partially surround the storage compartment 134 when the front cover 114 is in the closed position.

Accordingly, and in some implementations, the top sidewall 128 may be configured to provide a boundary that aligns with the top portion of the electronic device, the bottom sidewall 130 may be configured to provide a boundary that aligns with the bottom portion of the electronic device, and the lateral sidewall 132 may be configured to provide a partial boundary that aligns with the side portion of the electronic device (e.g., when the electronic device is releasably retained by the tray), and the storage compartment 134 may be configured to support the stylus 100a (e.g., when the stylus 100a is detachably stored, as described in more detail elsewhere herein).

In some implementations, a top surface of the tray may be flush with, or positioned vertically below, the front surface of the electronic device when the electronic device is releasably retained by the tray (e.g., top portions of the top sidewall 128, the bottom sidewall 130, the lateral sidewall 132, and the storage compartment 134 may be flush with, or positioned vertically below, the front surface of the electronic device when the electronic device is releasably retained). In this way, and in some implementations, there may be no portions of the tray that extend above the front surface of the electronic device when the electronic device is releasably retained by the tray, which provides enhanced holding comfort to the user of the protective case 100.

This configuration enables the electronic device to remain securely in place (e.g., via the top sidewall 128 and the bottom sidewall 130) until being removed by receiving a force, such as an upward or outward force provided by the user of the electronic device, that releases the electronic device from the rear cover 116 (e.g., releases the electronic device from the frictional interface connections associated with the top sidewall 128 and the bottom sidewall 130). Although the top sidewall 128, the bottom sidewall 130, and the storage compartment 134 have been described as including curved or rounded surfaces and the lateral sidewall 132 has been described as including a flat surface, the top sidewall 128, the bottom sidewall 130, the lateral sidewall 132, and the storage compartment 134 may include any suitable surfaces (e.g., configured to conform to one or more contours of the electronic device, among other examples).

In some implementations, the rear cover 116 may include a curved edge portion (e.g., shown as a curved peripheral edge 116a in FIGS. 2-3) and the top sidewall 128 and the bottom sidewall 130 may include tapered portions (e.g., as shown in FIGS. 2 and 4-5, the top sidewall 128 may include a first top tapered portion 128a and a second top tapered portion 128b, and, as shown in FIGS. 3 and 4-5, the bottom sidewall 130 may include a first bottom tapered portion 130a and a second bottom tapered portion 130b).

The first top tapered portion 128a and the first bottom tapered portion 130a may taper in a direction toward the curved peripheral edge 116a defining an open side of the tray (e.g., shown as a lateral opening 116b defined between the top sidewall 128 and the bottom sidewall 130), which enables easy attachment to, and removal from, the rear cover 116, as described in more detail elsewhere herein. Although the rear cover 116 is described as including the top sidewall 128, the bottom sidewall 130, the lateral sidewall 132, and the storage compartment 134, the rear cover 116 may include any suitable walls and/or surfaces (e.g., configured to releasably retain the electronic device and/or the stylus 100a), as described in more detail elsewhere herein.

In some implementations, the protective case 100 may include securing mechanisms to releasably secure one or more components of the protective case 100 to one another. Additionally, or alternatively, the securing mechanisms may releasably secure one or more components of the protective case 100 to the electronic device and/or to the stylus 100a, as described in more detail elsewhere herein.

In some implementations, the securing mechanisms may be magnets embedded in one or more components of the protective case 100, such as magnets embedded in the front cover 114 and/or the rear cover 116. For example, and as shown in FIG. 6, the protective case 100 may include a first magnet 136, a second magnet 138, a third magnet 140, a fourth magnet 142, a fifth magnet 144, a sixth magnet 146, a seventh magnet 148, an eighth magnet 150, a ninth magnet 152, and a tenth magnet 154.

The first magnet 136 may be embedded in the first portion 120 of the front cover 114 (e.g., positioned above the recesses 126 and below the top 102 of the protective case 100), the second magnet 138 may be embedded in the first portion 120 of the front cover 114 (e.g., positioned below the recesses 126 and above the bottom 104 of the protective case 100), the third magnet 140 may be embedded in the rear cover 116 (e.g., proximate the curved peripheral edge 116a and aligned with the first magnet 136), and the fourth magnet 142 may be embedded in the rear cover 116 (e.g., proximate the curved peripheral edge 116a and aligned with the second magnet 138).

The fifth magnet 144 may be embedded in the second portion 122 of the front cover 114 (e.g., positioned in partial alignment with the first magnet 136), the sixth magnet 146 may be embedded in the second portion of the front cover 114 (e.g., positioned in partial alignment with the second magnet 138), the seventh magnet 148 may be embedded in the rear cover 116 (e.g., positioned in alignment with the fifth magnet 144), and the eighth magnet 150 may be embedded in the rear cover 116 (e.g., positioned in alignment with the sixth magnet 146).

The ninth magnet 152 may be embedded in the lateral sidewall 132 (e.g., positioned in partial alignment with the seventh magnet 148) and the tenth magnet 154 may be embedded in the lateral sidewall 132 (e.g., positioned in partial alignment with the eighth magnet 150 and positioned in alignment with the ninth magnet 152).

In some implementations, the first magnet 136 and the second magnet 138 may interact with magnets embedded in the electronic device, such as when the front cover 114 is in the closed position to releasably secure the front cover 114 in the closed position (e.g., even if the electronic device is held in a position where the front surface of the electronic device is facing vertically downward).

In some implementations, the first magnet 136 may interact with the third magnet 140, the second magnet 138 may interact with the fourth magnet 142, the fifth magnet 144 may interact with the seventh magnet 148, and the sixth magnet 146 may interact with the eighth magnet 150, such as when the front cover 114 is in the second open position to releasably secure the front cover 114 in the second open position.

In some implementations, the ninth magnet 152 and the tenth magnet 154 may interact with magnets embedded in the stylus 100a, such as to detachably store (e.g., via a detachable magnetic connection) the stylus 100a within the storage compartment 134. Additionally, or alternatively, the ninth magnet 152 and the tenth magnet 154 may be positioned to allow the stylus 100a to be charged when the stylus 100a is within the storage compartment 134 and detachably connected to the lateral sidewall 132 and when the electronic device is releasably retained by the tray (e.g., charging contacts of the stylus 100a may be aligned with corresponding charging contacts on the electronic device when the stylus 100a is within the storage compartment 134 and detachably connected to the lateral sidewall 132).

In this way, the stylus 100a may be securely stored (e.g., detachably stored) within the storage compartment 134 and may be wirelessly charged when the stylus 100a is not in use (e.g., by aligning the charging contacts of the stylus 100a with the charging contacts of the electronic device via the detachable connection to the lateral sidewall 132). Although the securing mechanisms are described herein as magnets embedded in one or more portions of the protective case 100, the securing mechanisms may be any suitable securing mechanisms, such as mechanical clips, among other examples located in any suitable position associated with the protective case 100.

In some implementations, the protective case 100 may include a magnet 156 and a shield 158 embedded in the second portion 122 of the front cover 114. For example, the magnet 156 may be embedded in the second portion 122 of the front cover 114 and the shield 158 may be a metal plate embedded in the second portion 122 of the front cover 114 in proximity to the magnet 156. In some implementations, the magnet 156 and the shield 158 may be configured to allow the electronic device to transition between operation modes (e.g., between a sleep mode and an active mode), as described in more detail elsewhere herein.

For example, if the electronic device is in a wake mode and the front cover 114 transitions from the first open position to the closed position, the magnet 156 embedded in the front cover 114 may interact with a sensor provided on the electronic device (e.g., a hall effect sensor embedded in the electronic device) to transition from the wake mode to a sleep mode. If the front cover 114 is moved from the closed position to the second open position, the electronic device may transition from the sleep mode to the wake mode (e.g., because the magnet 156 embedded in the front cover 114 does not interact with the hall effect sensor embedded in the electronic device) and may remain in the wake mode when the front cover 114 is in the second open position (e.g., because the shield 158 prevents the magnet 156 embedded in the front cover 114 from interacting with the hall effect sensor embedded in the electronic device).

In some implementations, the rear cover 116 may define an opening 160 (e.g., as shown in FIGS. 7 and 9) configured to align with a power button of the electronic device. This alignment ensures that, when the electronic device is fully seated within the tray of the rear cover 116, the opening 160 remains positioned over the power button. As a result, the user of the electronic device may easily access the power button while the electronic device is releasably retained by the tray.

As indicated above, FIGS. 1-9 are provided as examples. Other examples may differ from what is described with regard to FIGS. 1-9.

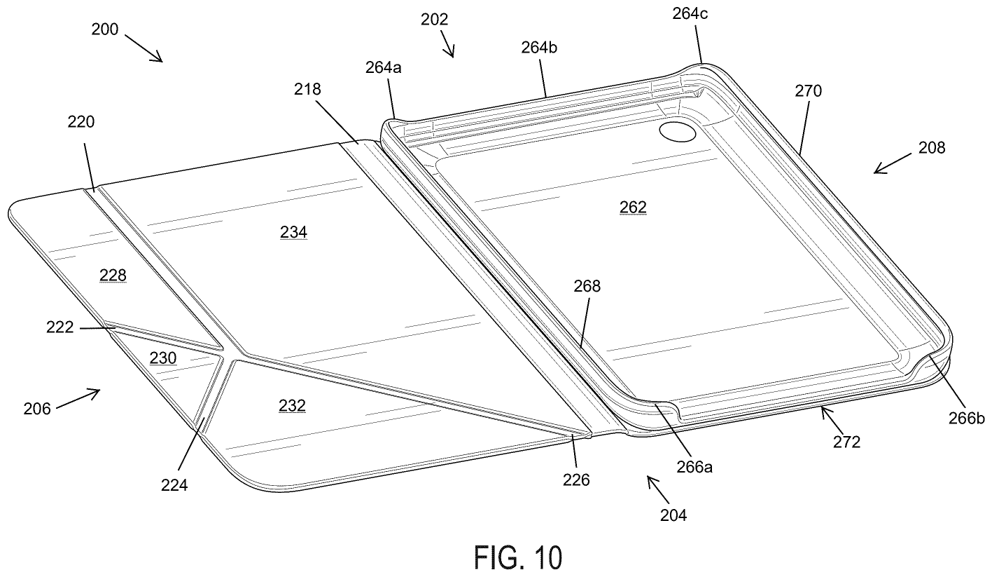

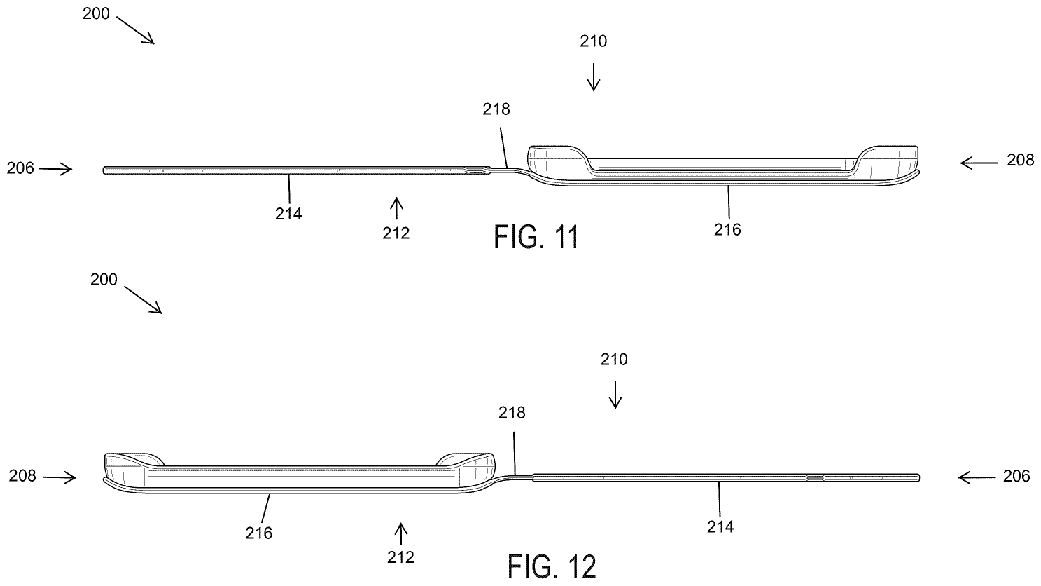

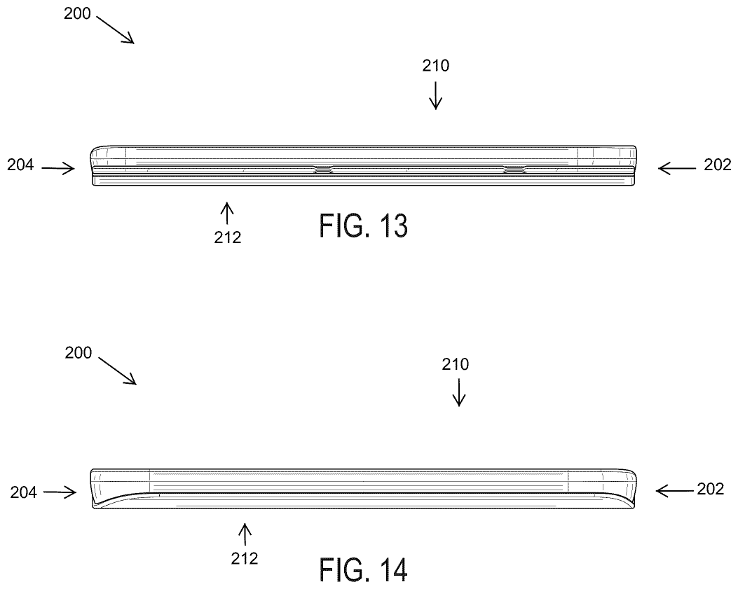

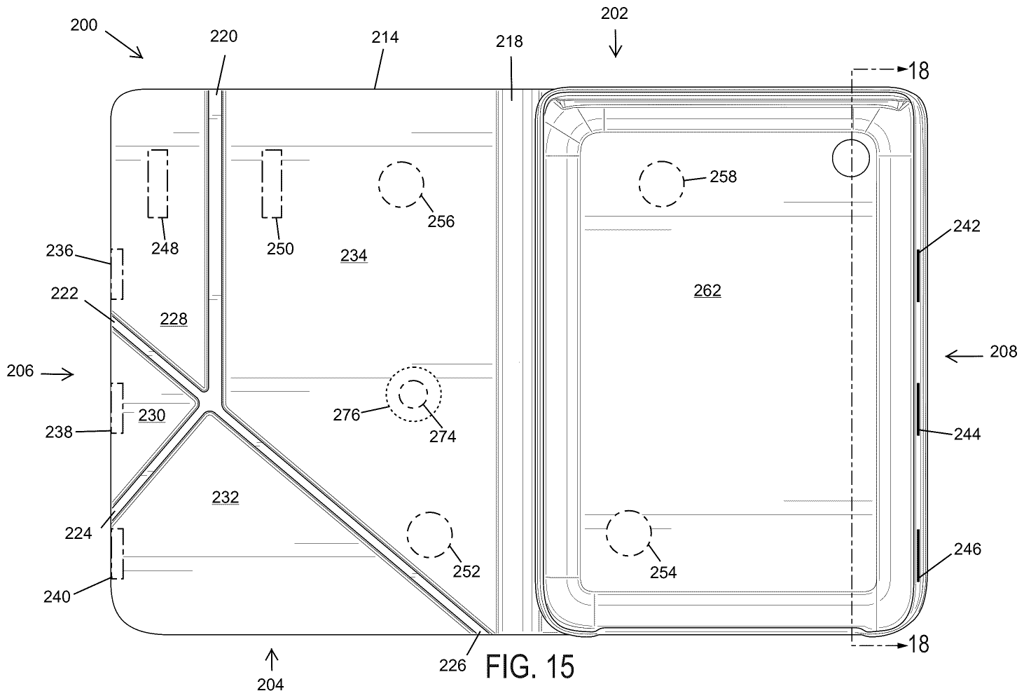

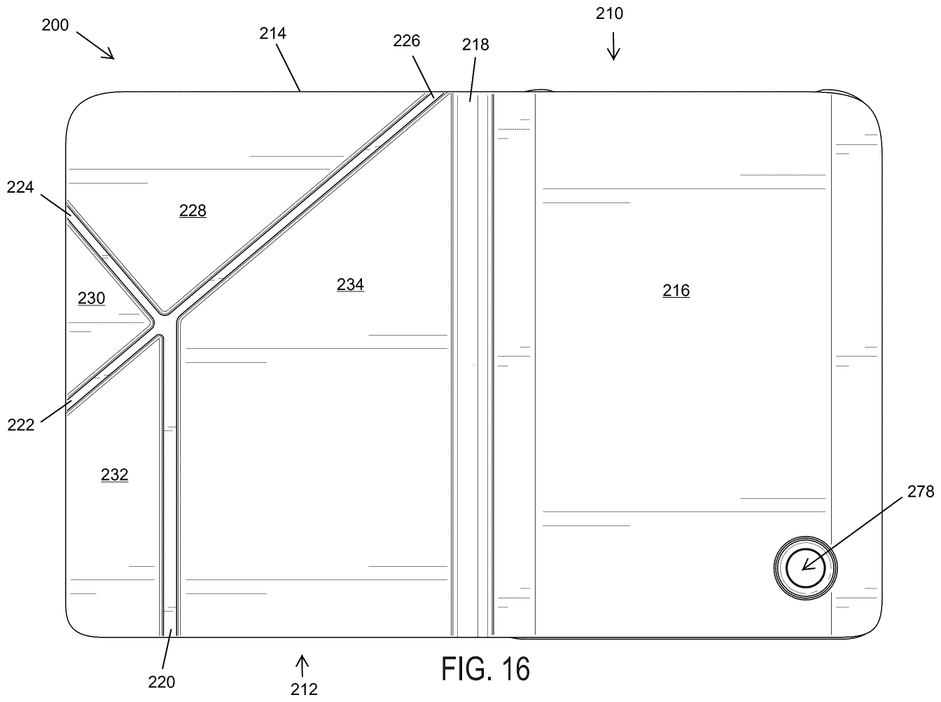

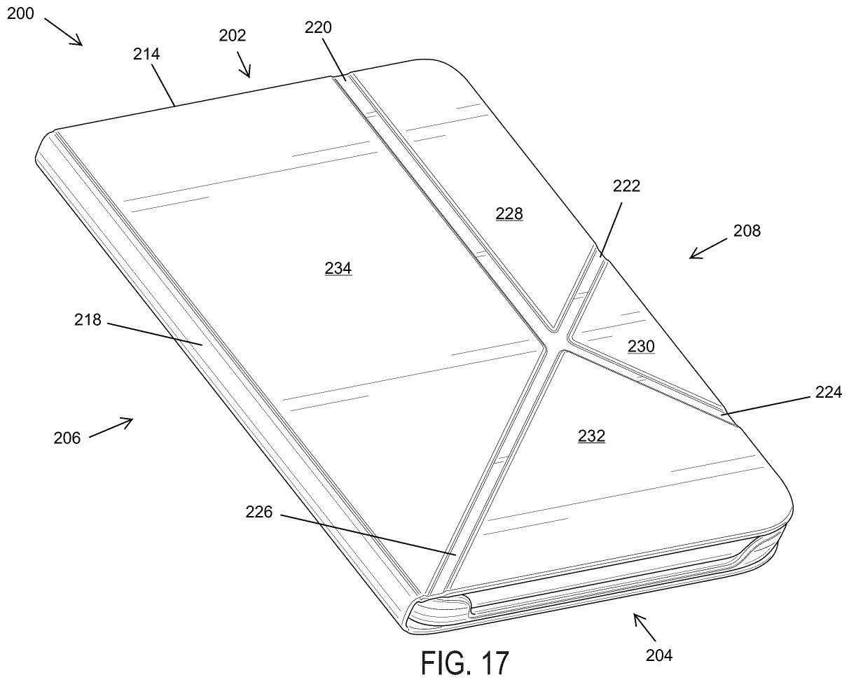

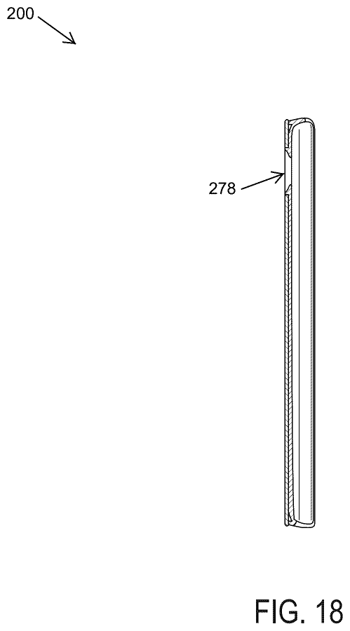

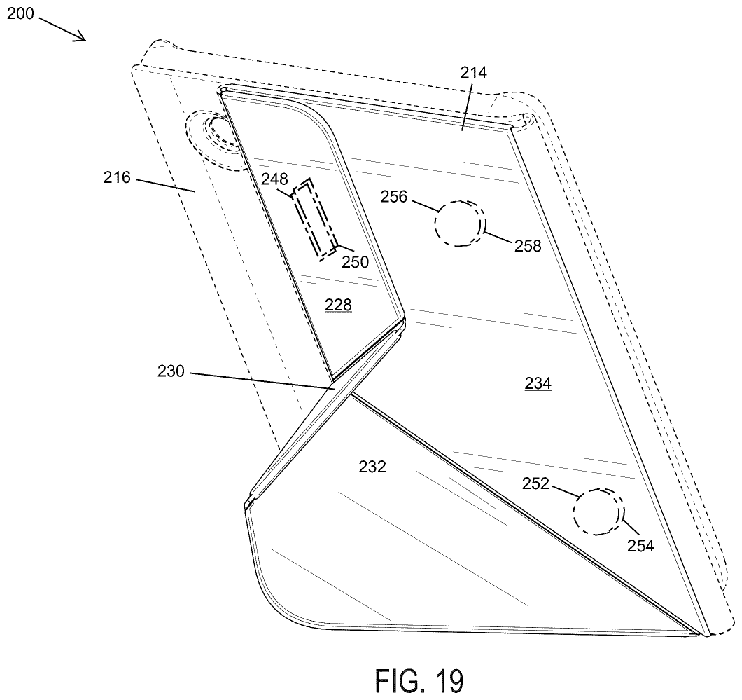

FIGS. 10-19 are diagrams of an example protective case 200 as described in more detail elsewhere herein. In some implementations, the protective case 200 may be associated with a closed position, an open position, and a stand position (or a stand configuration). FIGS. 10-16 are diagrams of the protective case 200 in the open position (e.g., FIG. 10 is a perspective view, FIG. 11 is a bottom view, FIG. 12 is a top view, FIG. 13 is a left view, or a first side view, FIG. 14 is a right view, or a second side view, FIG. 15 is a front view, and FIG. 16 a rear view of the protective case 200 in the open position). FIG. 17 is a perspective view of the protective case 200 in the closed position. FIG. 18 is a cross section taken along line 18-18 of FIG. 15. FIG. 19 is a perspective view of the protective case 200 in the stand position.

In some implementations, the protective case 200 may be configured to protect an electronic device (e.g., an electronic reading device, among other examples). As shown in FIGS. 10-19, the protective case 200 includes a top 202, a bottom 204, a first side (e.g., shown as a left side 206), a second side (e.g. shown as a right side 208), a front 210, a rear 212, a front cover 214, a rear cover 216, and a hinge (e.g., shown as a folding hinge 218) that operatively couples the front cover 214 to the rear cover 216. The folding hinge 218 may define a hinge axis that enables movement of the front cover 214 relative to the rear cover 216, as described in more detail elsewhere herein.

The front cover 214 may be movable between the closed position (e.g., corresponding to a fully closed position) and the open position (e.g., corresponding to a fully open position). When the front cover 214 is in the closed position (e.g., as shown in FIG. 17), the front cover 214 overlies and protects a front surface (e.g., a touchscreen) of the electronic device.

In some implementations, the front cover 214 may be movable into multiple open positions, such as a first open position or a second open position, that expose the front surface of the electronic device. As an example, and when the front cover 214 is in the first open position, the front cover 214 and the rear cover 216 may be positioned laterally adjacent to one another (e.g., as shown in FIGS. 10-16). As another example, and when the front cover 214 is in the second open position, an exterior surface of the front cover 214 may be in contact with an exterior surface of the rear cover 216. The front cover 214 may be releasably secured in the second open position as described in more detail elsewhere herein.

As shown in FIG. 19, the front cover 214 may be foldable into the stand position (e.g., the front cover 214 may be foldable into the stand position from the second open position, among other examples). The front cover 214 may include a first crease 220, a second crease 222, a third crease 224, and a fourth crease 226 that define a first section 228, a second section 230, a third section 232, and a fourth section 234. The first section 228, the second section 230, the third section 232, and the fourth section 234 may be foldable according to a folding pattern (e.g., to move the front cover 214 into the stand position), as described in more detail elsewhere herein.

In some implementations, the first section 228, the third section 232, and the fourth section 234 may be in a shape of a trapezoid with a rounded edge and the second section 230 may be in a shape of a triangle. The first section 228 may be bordered by the first crease 220 and the second crease 222, the second section 230 may be bordered by the second crease 222 and the third crease 224, the third section 232 may be bordered by the third crease 224 and the fourth crease 226, and the fourth section 234 may be bordered by the first crease 220 and the fourth crease 226.

In some implementations, the front cover 214 may be movable into the stand position based on movement of the first section 228 from a first position (e.g., a non-folded position) to a second position (e.g., a folded position as shown in FIG. 19). For example, movement of the first section 228 into the folded position may cause the front cover 214 to transition to the stand position (e.g., from the second open position) by causing the second section 230 to move about the second crease 222 and about the third crease 224 into a first support position (e.g., as shown in FIG. 19) and by causing the third section 232 to move about the third crease 224 and the fourth crease 226 into a second support position (e.g., as shown in FIG. 19).

In some implementations, and when the second section 230 is moving into the first support position, movement of the second section 230 about the second crease 222 and about the third crease 224 is in opposite directions. When the second section 230 is in the first support position and the third section 232 is in the second support position, interior surfaces of the second section 230 and the third section 232 may not be in contact with one another. In other words, a space may be present between the interior surfaces of the second section 230 and the third section 232 when the second section 230 is in the first support position and the third section 232 is in the second support position.

Accordingly, and in some implementations, the front cover 214 may be movable into the stand position by folding a single section into a folded position (e.g., folding the first section 228 into the folded position causes the second section 230 to move into the first support position and the third section 232 to move into the second support position).

The first section 228 may be releasably secured in the folded position (e.g., an interior surface of the first section 228 may be releasably secured to an interior surface of the fourth section 234), as described in more detail elsewhere herein. In some implementations, an interior surface of the second section 230 may face an interior surface of the third section 232 when the second section 230 is in the first support position and the third section 232 is in the second support position.

In some implementations, and when the front cover 214 is in the stand position, a front surface of the rear cover 216 may be at an angle of approximately 50 degrees relative to a support surface. In this way, when the electronic device is releasably retained by the rear cover 216, a screen of the electronic device may be viewable at an angle of approximately 50 degrees to provide an optimized viewing angle to a user of the electronic device.

In some implementations, the protective case 200 may include securing mechanisms to releasably secure one or more components of the protective case 200 to one another, as described in more detail elsewhere herein. Additionally, or alternatively, the securing mechanisms may releasably secure one or more components of the protective case 200 to the electronic device.

In some implementations, the securing mechanisms may be magnets embedded in one or more components of the protective case 200, such as magnets embedded in the front cover 214 and/or the rear cover 216, as described in more detail elsewhere herein. For example, and as shown in FIG. 15, the protective case 200 may include a first magnet 236, a second magnet 238, a third magnet 240, a fourth magnet 242, a fifth magnet 244, a sixth magnet 246, a seventh magnet 248, an eighth magnet 250, a ninth magnet 252, a tenth magnet 254, an eleventh magnet 256, and a twelfth magnet 258.

The first magnet 236 may be embedded in the first section 228 of the front cover 214 (e.g., proximate a peripheral edge of the first section 228), the second magnet 238 may be embedded in the second section 230 of the front cover 214 (e.g., proximate a peripheral edge of the second section 230), and the third magnet 240 may be embedded in the third section 232 of the front cover 214 (e.g., proximate a peripheral edge of the third section 232). The fourth magnet 242, the fifth magnet 244, the sixth magnet 246, the tenth magnet 254, and the twelfth magnet 258 may be embedded in the rear cover 116, as described in more detail elsewhere herein. For example, the fourth magnet 242 may be embedded in the rear cover 216 at a position enabling interactions with the first magnet 236, the fifth magnet 244 may be embedded in the rear cover 216 at a position enabling interactions with the second magnet 238, the sixth magnet 246 may be embedded in the rear cover 216 at a position enabling interactions with the third magnet 240, the tenth magnet 254 may be embedded in the rear cover 216 at a position enabling interactions with the ninth magnet 252, and the twelfth magnet 258 may be embedded in the rear cover 216 at a position enabling interactions with the eleventh magnet 256.

In some implementations, the first magnet 236 may interact with the fourth magnet 242, the second magnet 238 may interact with the fifth magnet 244, and the third magnet 240 may interact with the sixth magnet 246, such as when the front cover 214 is in the closed position to releasably secure the front cover 214 in the closed position (e.g., even if the electronic device is held in a position where the front surface of the electronic device is facing vertically downward).

In some implementations, the seventh magnet 248 may interact with the eighth magnet 250, such as when the front cover 214 is in the stand position to releasably secure the first section 228 to the fourth section 234 (e.g., as shown in FIG. 19), as described in more detail elsewhere herein.

In some implementations, the ninth magnet 252 may interact with the tenth magnet 254 and the eleventh magnet 256 may interact with the twelfth magnet 258, such as when the front cover 214 is in the second open position and/or when the front cover is in the stand position (e.g., as shown in FIG. 19). Although the securing mechanisms are described herein as magnets embedded in one or more portions of the protective case 200, the securing mechanisms may be any suitable securing mechanisms, such as mechanical clips, among other examples located in any suitable position associated with the protective case 200.

In some implementations, the first section 228 may be folded along the first crease 220 such that an interior surface of the first section 228 is in contact with an interior surface of the fourth section 234 (e.g., as shown in FIG. 19, the interior surface of the first section 228 may be releasably secured to the interior surface of the fourth section 234 via the seventh magnet 248 and the eighth magnet 250). Folding of the first section 228 along the first crease 220 causes the second section 230 and the third section 232 to move (e.g., the second section 230 moves into the first support position and the third section 232 moves not the second support position), as described in more detail elsewhere herein.

In some implementations, the electronic device may include a power button provided on a rear of the electronic device. When the front cover 214 is in the stand position, the power button of the electronic device may be accessible (e.g., because the first section 228 is releasably secured in the folded position, the user may have access to the power button when the front cover 214 is in the stand position).

In some implementations, the rear cover 216 may be configured to releasably retain the electronic device. For example, the rear cover 216 may include a retaining portion configured to releasably retain the electronic device, as described in more detail elsewhere herein.

In some implementations, the retaining portion may be formed as a tray including an interior surface 262, a first top portion (e.g., a first top sidewall portion 264a), a second top portion (e.g., a second top sidewall portion 264b), a third portion (e.g., a third top sidewall portion 264c), a first bottom portion (e.g., a first bottom sidewall portion 266a), a second bottom portion (e.g., a second bottom sidewall portion 266b), a first lateral sidewall 268, and a second lateral sidewall 270. For example, the tray may be formed from a polymer and/or a polymer-based material through an injection molding process with the tray including (e.g., integrally including) the interior surface 262, the first top sidewall portion 264a, second top sidewall portion 264b, a third top sidewall portion 264c, a first bottom sidewall portion 266a, a second bottom sidewall portion 266b, a first lateral sidewall 268, and a second lateral sidewall 270 (e.g., the interior surface 262 may transition into the first top sidewall portion 264a, the second top sidewall portion 264b, the third top sidewall portion 264c, the first bottom sidewall portion 266a, the second bottom sidewall portion 266b, the first lateral sidewall 268, and the second lateral sidewall 270).

The first top sidewall portion 264a may transition from the first lateral sidewall 268 into the second top sidewall portion 264b (e.g., as shown in FIG. 10, the first top sidewall portion 264a may taper downwardly at an angle from the first lateral sidewall 268 to the second top sidewall portion 264b). The second top sidewall portion 264b may transition into the third top sidewall portion 264c (e.g., as shown in FIG. 10, the second top sidewall portion 264b may taper upwardly at an angle upward angle into the third top sidewall portion 264c). The third top sidewall portion 264c may transition into the second lateral sidewall 270.

The first lateral sidewall 268 may transition into the first bottom sidewall portion 266a. The first bottom sidewall portion 266a may transition into the interior surface 262 (e.g., as shown in FIG. 10, the first bottom sidewall portion 266a may taper downwardly at an angle into the interior surface 262). The second lateral sidewall 270 may transition into the second bottom sidewall portion 266b. The second bottom sidewall portion 266b may transition into the interior surface 262 (e.g., as shown in FIG. 10, the second bottom sidewall portion 266b may taper downwardly at an angle into the interior surface 262).

Accordingly, and in some implementations, the first bottom sidewall portion 266a and the second bottom sidewall portion 266b may define a bottom opening (e.g., shown as a bottom opening 272 provided proximate the bottom 204 of the rear cover 216 in FIG. 10 as shown in FIG. 10). In some implementations, the bottom opening 272 may enable access to one or more components of the electronic device (e.g., when the electronic device is releasably retained by the tray). For example, the bottom opening 272 may enable access to a universal serial bus type-C (USB-C) port and/or the power button of the electronic device when the electronic device is releasably retained by the tray, among other examples.

In some implementations, the first top sidewall portion 264a, the third top sidewall portion 264c, the first bottom sidewall portion 266a, the second bottom sidewall portion 266b, the first lateral sidewall 268, and the second lateral sidewall 270 may include curved or rounded surfaces (e.g., the curved or rounded surfaces may have partially circular cross sections, among other examples), and the second top sidewall portion 264b may include a flat surface. The curved or rounded surfaces of the first top sidewall portion 264a, the third top sidewall portion 264c, the first bottom sidewall portion 266a, the second bottom sidewall portion 266b, the first lateral sidewall 268, and the second lateral sidewall 270 may be configured to releasably retain the electronic device (e.g., via a frictional interface connection between the first top sidewall portion 264a, the third top sidewall portion 264c, the first bottom sidewall portion 266a, the second bottom sidewall portion 266b, the first lateral sidewall 268, and the second lateral sidewall 270 and the electronic device).

Accordingly, and in some implementations, the first top sidewall portion 264a, the second top sidewall portion 264b, and the third top sidewall portion 264c may be configured to provide a boundary that aligns with one or more top portions of the electronic device, the first bottom sidewall portion 266a and the second bottom sidewall portion 266b may be configured to provide a boundary that aligns with one or more bottom portions of the electronic device, and the first lateral sidewall 268 and the second lateral sidewall 270 may be configured to provide a boundary that aligns with one or more side portions of the electronic device.

In some implementations, a top surface of the tray may be flush with, or positioned vertically below, the front surface of the electronic device when the electronic device is releasably retained by the tray (e.g., top portions of the first top sidewall portion 264a, the second top sidewall portion 264b, the third top sidewall portion 264c, the first bottom sidewall portion 266a, the second bottom sidewall portion 266b, the first lateral sidewall 268, and the second lateral sidewall 270 may be flush with, or positioned vertically below, the front surface of the electronic device when the electronic device is releasably retained by the tray). In this way, and in some implementations, there may be no portions of the tray that extend above the front surface of the electronic device when the electronic device is releasably retained by the tray, which provides enhanced holding comfort to the user of the protective case 200.

This configuration enables the electronic device to remain securely in place (e.g., via the first top sidewall portion 264a, the second top sidewall portion 264b, the third top sidewall portion 264c, the first bottom sidewall portion 266a, the second bottom sidewall portion 266b, the first lateral sidewall 268, and the second lateral sidewall 270) until being removed by receiving a force, such as an upward or outward force provided by the user of the electronic device, that releases the electronic device from the rear cover 216 (e.g., releases the electronic device from the frictional interface connections associated with the first top sidewall portion 264a, the second top sidewall portion 264b, the third top sidewall portion 264c, the first bottom sidewall portion 266a, the second bottom sidewall portion 266b, the first lateral sidewall 268, and the second lateral sidewall 270).

Although the first top sidewall portion 264a, the third top sidewall portion 264c, the first bottom sidewall portion 266a, the second bottom sidewall portion 266b, the first lateral sidewall 268, and the second lateral sidewall 270 have been described as including curved or rounded surfaces, and the second top sidewall portion 264b has been described as having a flat surface, the first top sidewall portion 264a, the second top sidewall portion 264b, the third top sidewall portion 264c, the first bottom sidewall portion 266a, the second bottom sidewall portion 266b, the first lateral sidewall 268, and the second lateral sidewall 270 may include any suitable surfaces (e.g., configured to conform to one or more contours of the electronic device, among other examples).

In some implementations, the fourth magnet 242, the fifth magnet 244, and the sixth magnet 246 may be embedded in the second lateral sidewall 270, and the tenth magnet 254 and the twelfth magnet 258 may be embedded underneath the interior surface 262. In some implementations, the protective case 200 may include a magnet 274 and a shield 276 embedded in the front cover 214. For example, the magnet 274 may be embedded in the fourth section 234 of the front cover 214 and the shield 276 may be a metal plate embedded in the fourth section 234 of the front cover 214 (e.g., in proximity to the magnet 274). In some implementations, the magnet 274 and the shield 276 may be configured to allow the electronic device to transition between operation modes (e.g., between a sleep mode and an active mode), as described in more detail elsewhere herein.

For example, if the electronic device is in a wake mode and the front cover 214 transitions from the first open position to the closed position, the magnet 274 embedded in the front cover 214 may interact with a sensor provided on the electronic device (e.g., a hall effect sensor embedded in the electronic device causing) the electronic device to transition from the wake mode to a sleep mode. If the front cover 214 is moved from the closed position to the second open position or the stand position, the electronic device may transition from the sleep mode to the wake mode (e.g., because the magnet 274 embedded in the front cover 214 does not interact with the hall effect sensor embedded in the electronic device) and may remain in the wake mode when the front cover 214 is in the second open position or the stand position (e.g., because the shield 276 prevents the magnet 274 embedded in the front cover 214 from interacting with the hall effect sensor embedded in the electronic device).

In some implementations, the rear cover 216 may define an opening (e.g., shown as an opening 278 in FIGS. 16 and 18) configured to align with a component of the electronic device (e.g., a power button of the electronic device) when the electronic device is releasably retained by the tray.

This alignment ensures that, when the electronic device is releasably retained by the tray, the opening 278 is aligned with the power button. As a result, the user of the protective case 200 may easily access the power button of the electronic device when the electronic device is releasably retained by the tray. Additionally, because the first section 228 may be releasably secured in the folded position when the front cover 214 is in the stand position, the power button remains accessible when the front cover 214 is in the stand position.

Accordingly, and in some implementations, the protective case 200 may include a rear cover configured to releasably retain an electronic device, a front cover including multiple sections, and a hinge operatively connecting the front cover to the rear cover, defining a hinge axis. The front cover may be movable, relative to the rear cover and about the hinge axis, between a closed position, an open position, and a stand position. A section, of the multiple sections, may be movable between a first position and a second position. Movement of the section into the second position causes movement of the other sections causing the front cover to move into the stand position.

In some implementations, the front cover may include a first crease, a second crease, a third crease, and a fourth crease that define a first section, a second section, a third section, and a fourth section. The first section, the second section, the third section, and the fourth section may be foldable according to a folding pattern (e.g., to move the front cover into the stand position), as described in more detail elsewhere herein.

In some implementations, the first section, the third section, and the fourth section may be in a shape of a trapezoid with a rounded edge and the second section may be in a shape of a triangle. The first section may be bordered by the first crease and the second crease, the second section may be bordered by the second crease and the third crease, the third section may be bordered by the third crease and the fourth crease, and the fourth section may be bordered by the first crease and the fourth crease.

The front cover may be movable into the stand position based on movement of the first section from a first position (e.g., a non-folded position) to a second position (e.g., a folded position). For example, movement of the first section into the folded position may cause the front cover to transition to the stand position (e.g., from the second open position) by causing the second section to move about the second crease and about the third crease into a first support position and by causing the third section to move about the third crease and the fourth crease into a second support position. Accordingly, and in some implementations, the front cover may be movable into the stand position by folding a single section into a folded position (e.g., folding the first section into the folded position causes the second section to move into the first support position and the third section to move into the second support position).

The first section may be releasably secured in the folded position (e.g., an interior surface of the first section may be releasably secured to an interior surface of the fourth section), such as via magnetic coupling. In some implementations, an interior surface of the second section may face an interior surface of the third section when the second section is in the first support position and the third section is in the second support position.

In some implementations, and when the front cover is in the stand position, a front surface of the rear cover may be at an angle of approximately 50 degrees relative to a support surface. In this way, when the electronic device is releasably retained by the rear cover, a screen of the electronic device may be viewable at an angle of approximately 50 degrees to provide an optimized viewing angle to a user of the electronic device.

As indicated above, FIGS. 10-19 are provided as examples. Other examples may differ from what is described with regard to FIGS. 10-19.

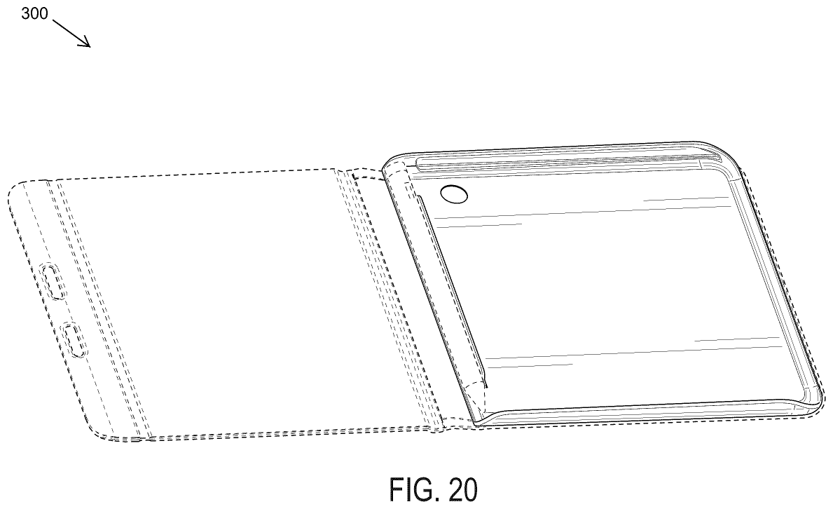

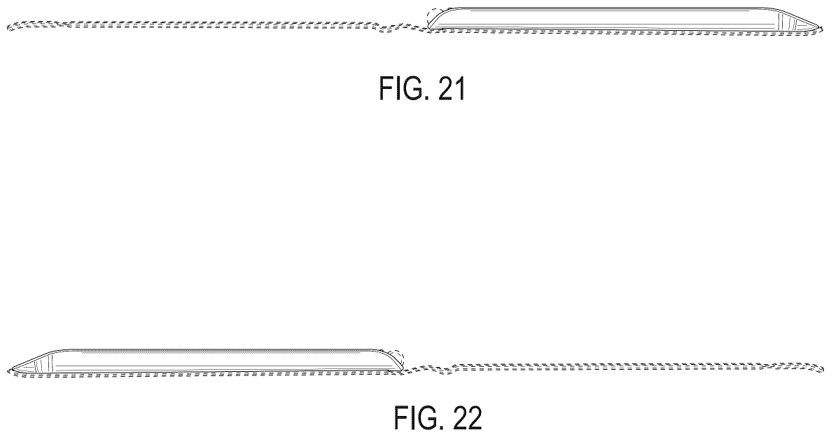

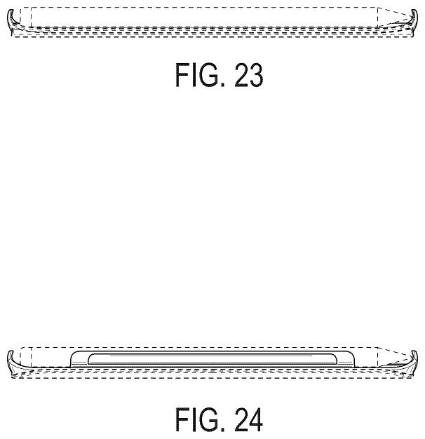

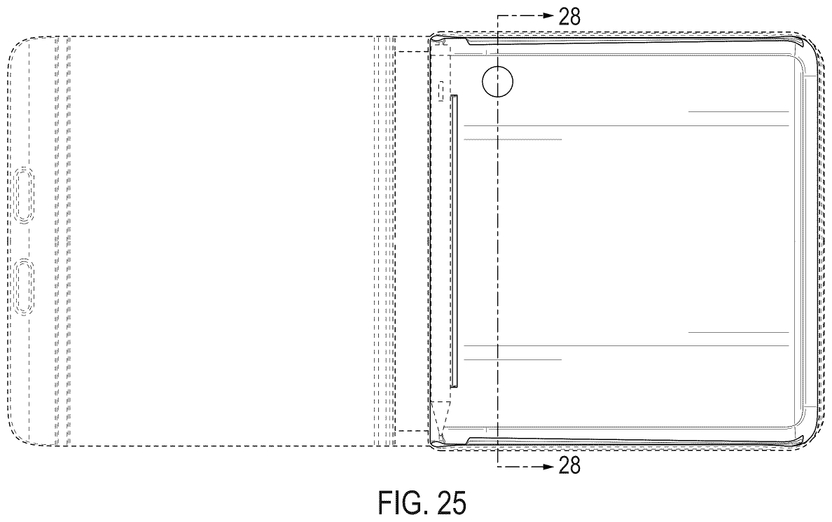

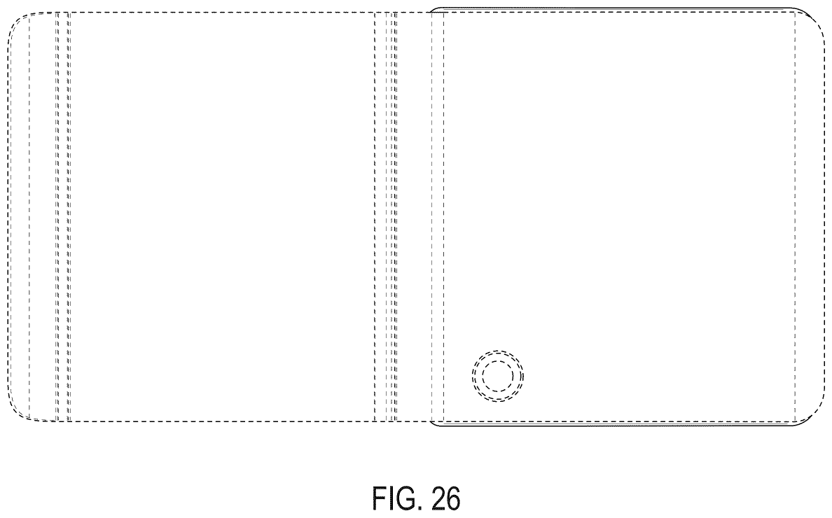

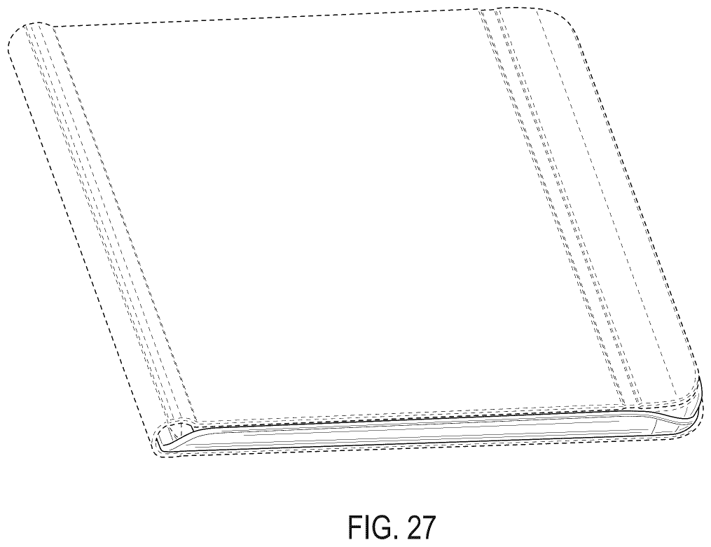

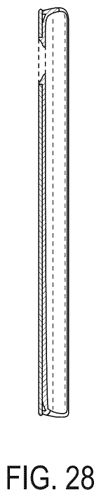

FIGS. 20-28 are diagrams of an example protective case 300, as described in more detail elsewhere herein. In some implementations, the protective case 300 may be configured to protect an electronic device (e.g., an electronic reader (e-reader) device, among other examples) and/or a stylus. FIGS. 20-26 are diagrams of the protective case 300 in the open position (e.g., FIG. 20 is a perspective view, FIG. 21 is a bottom view, FIG. 22 is a top view, FIG. 23 is a left view, or a first side view, FIG. 24 is a right view, or a second side view, FIG. 25 is a front view, and FIG. 26 a rear view of the protective case 300 in the open position). FIG. 27 is a perspective view of the protective case 300 in the closed position. FIG. 28 is a cross section taken along line 28-28 of FIG. 25.

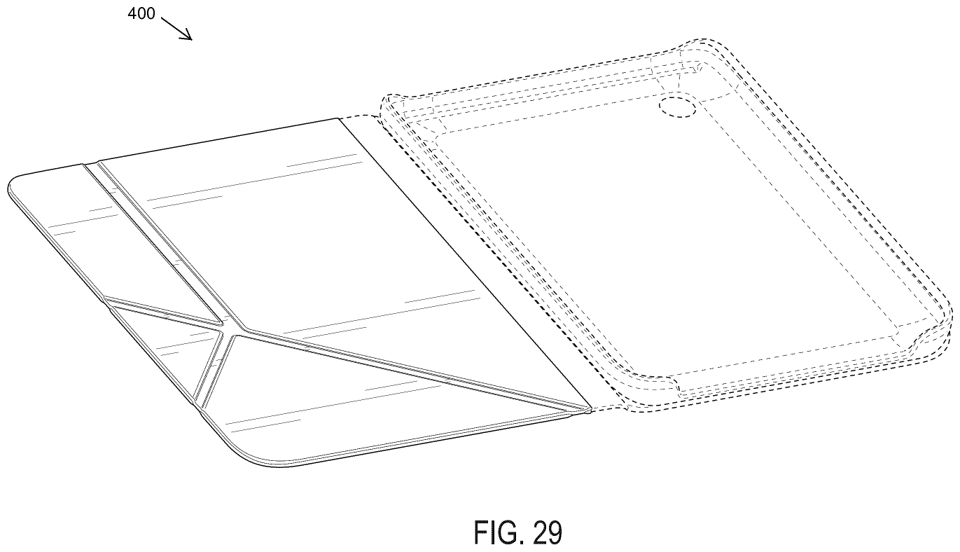

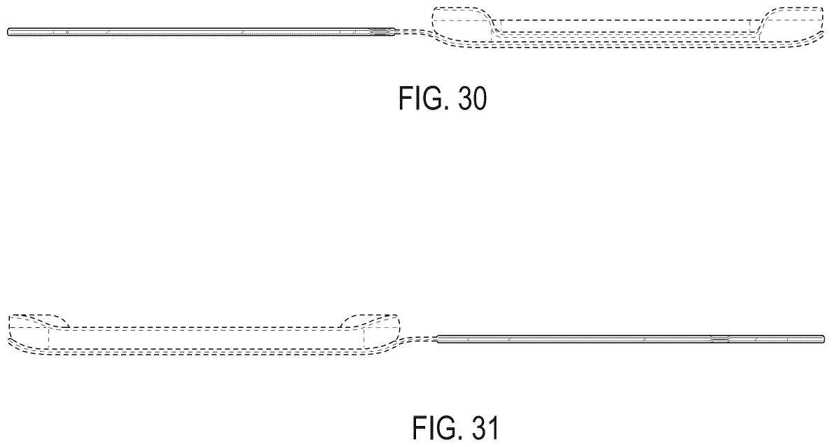

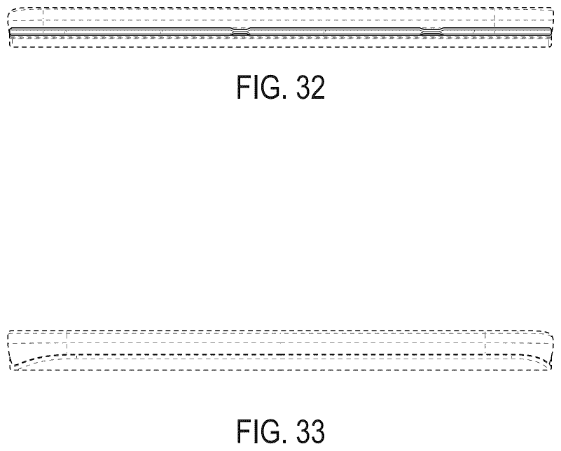

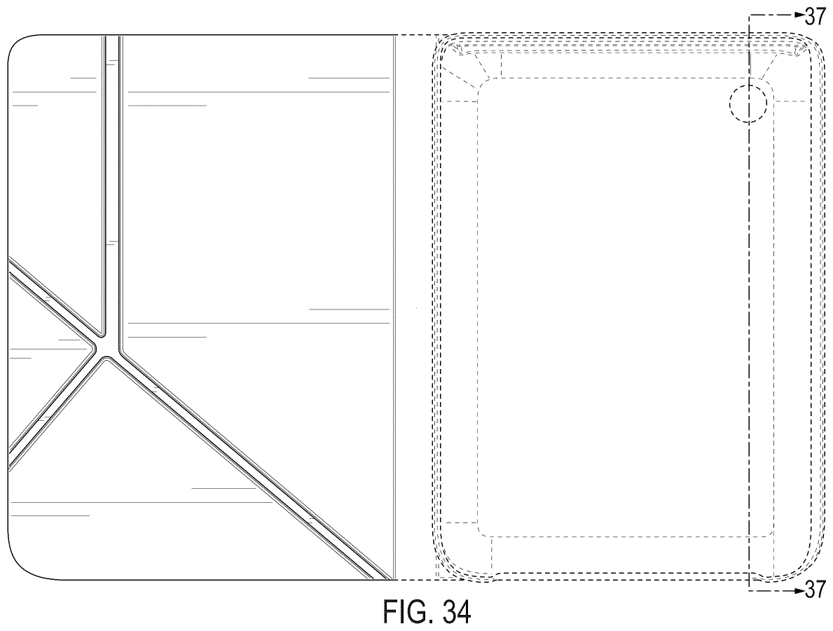

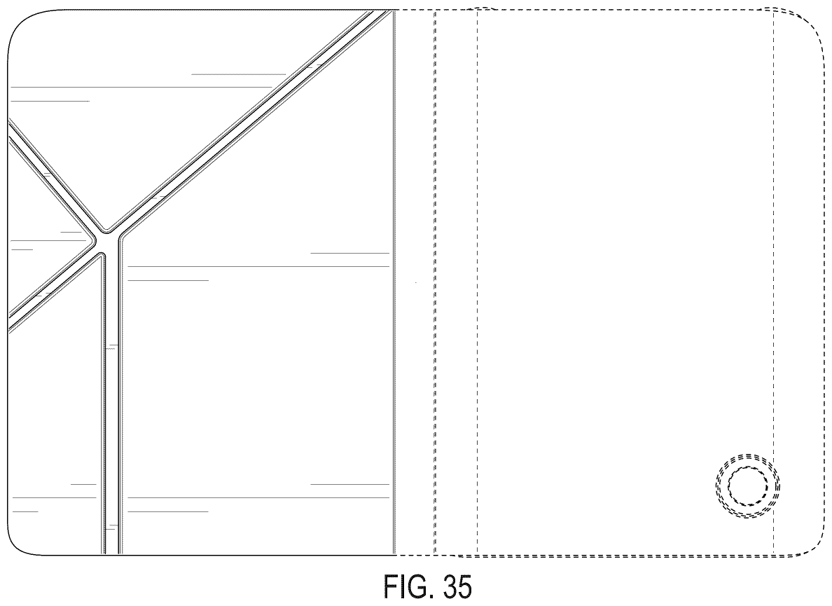

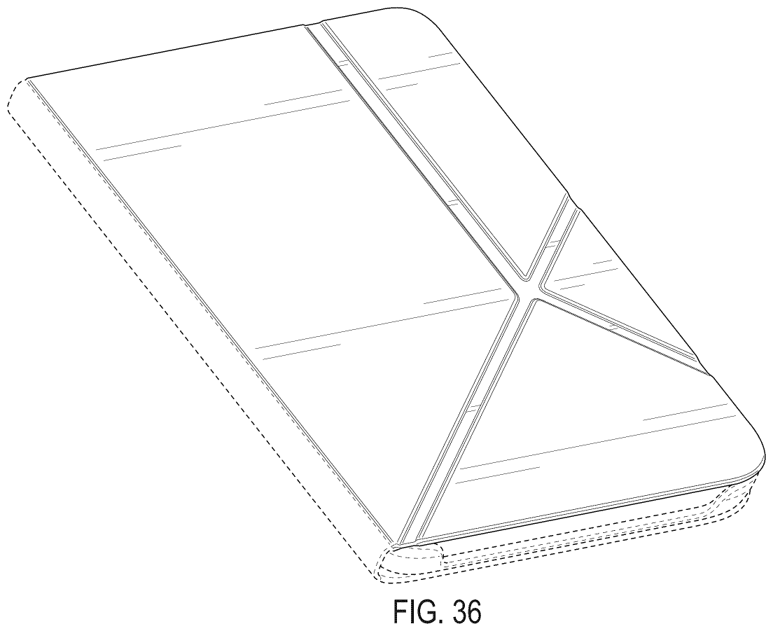

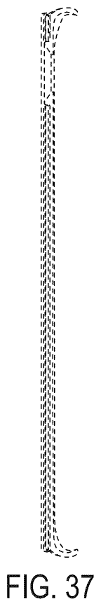

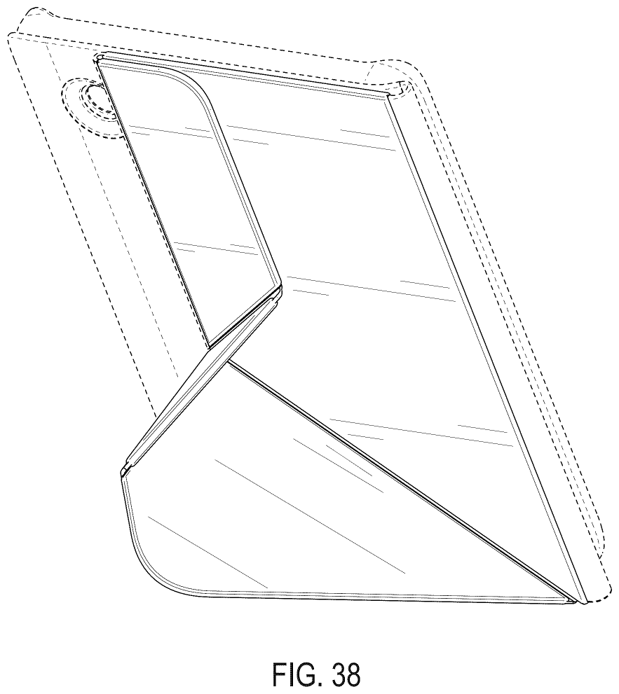

FIGS. 29-38 are diagrams of an example protective case 400, as described in more detail elsewhere herein. In some implementations, the protective case 400 may be configured to protect an electronic device. FIGS. 29-35 are diagrams of the protective case 400 in the open position (e.g., FIG. 29 is a perspective view, FIG. 30 is a bottom view, FIG. 31 is a top view, FIG. 32 is a left view, or a first side view, FIG. 33 is a right view, or a second side view, FIG. 34 is a front view, and FIG. 35 a rear view of the protective case 400 in the open position). FIG. 36 is a perspective view of the protective case 400 in the closed position. FIG. 37 is a cross section taken along line 37-37 of FIG. 34. FIG. 38 is a perspective view of the protective case 400 in a stand position.

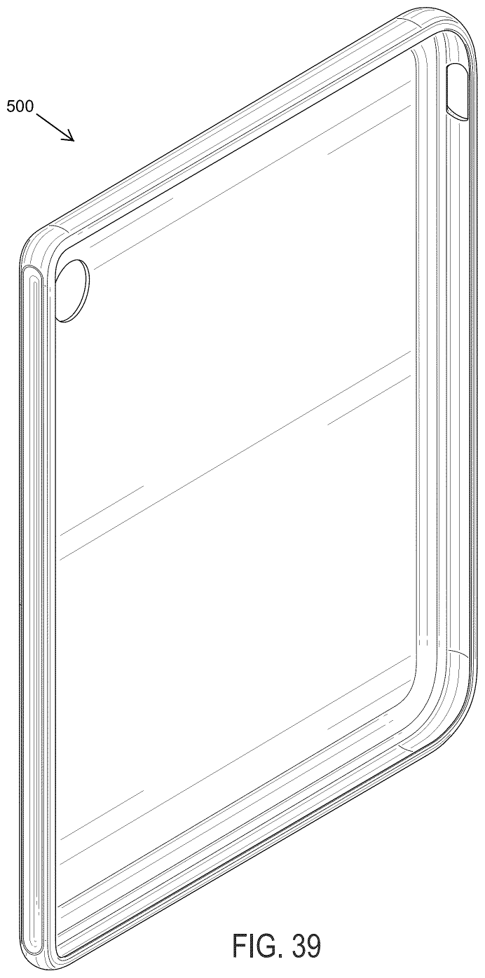

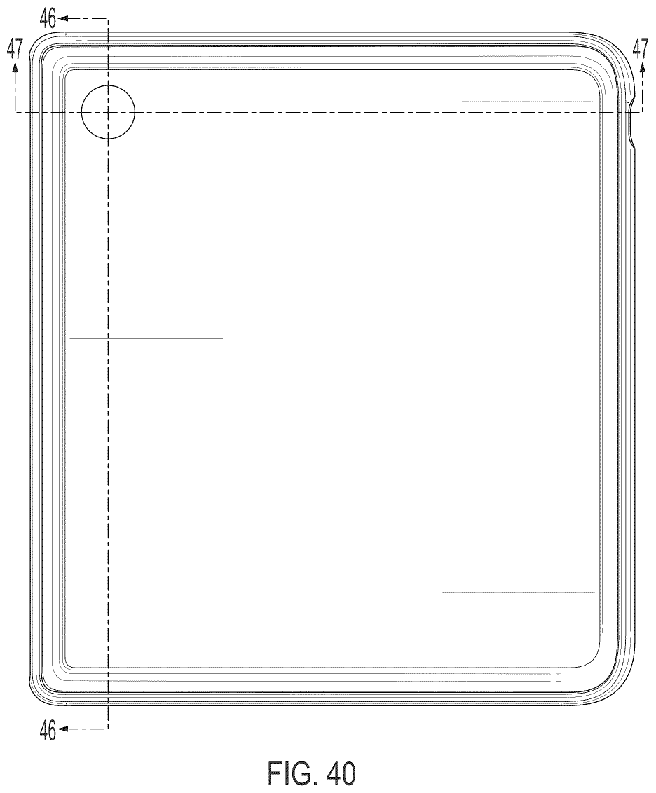

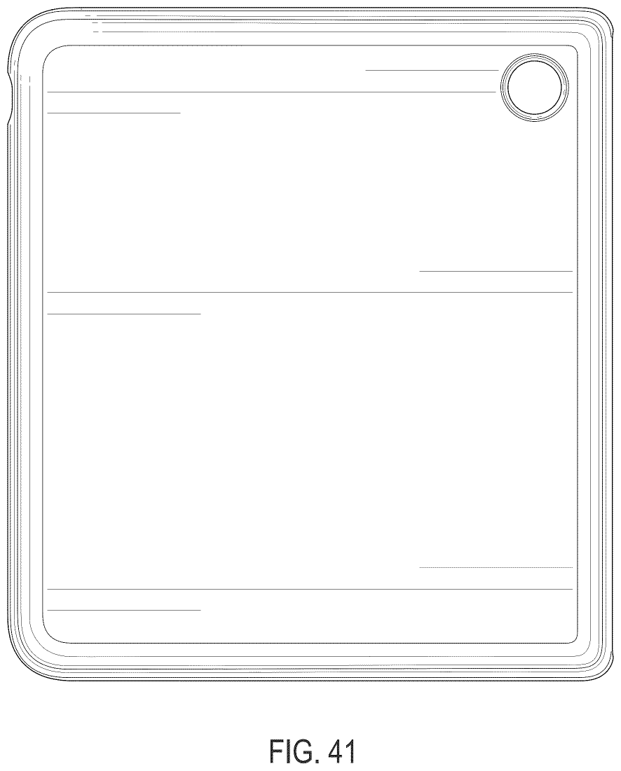

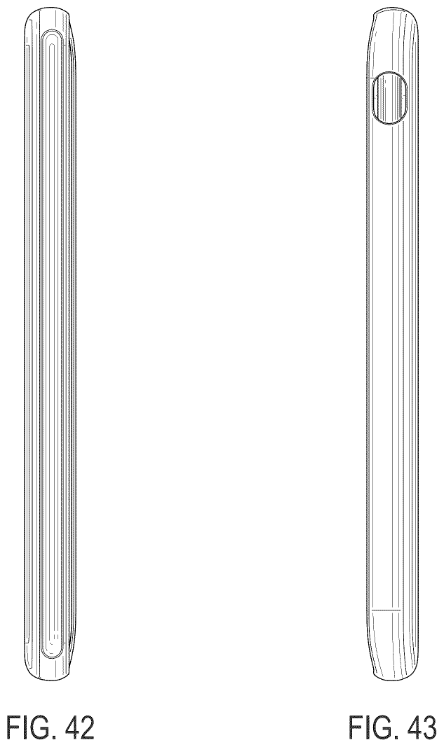

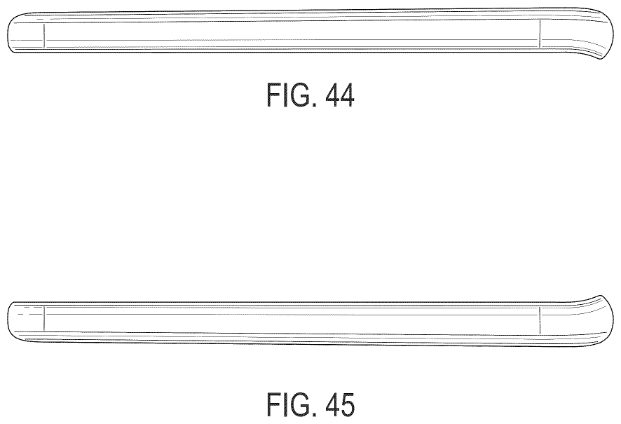

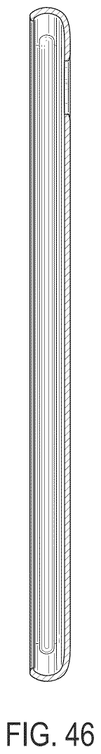

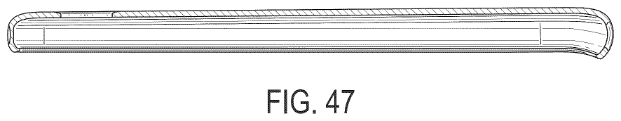

FIGS. 39-47 are diagrams of an example protective case 500, as described in more detail elsewhere herein. In some implementations, the protective case 500 may be configured to protect an electronic device. FIG. 39 is a front perspective view, FIG. 40 is a front plan view, FIG. 41 is a rear plan view, FIG. 42 is a left elevation view, FIG. 43 is a right elevation view, FIG. 44 is a top elevation view, and FIG. 45 is a bottom elevation view of the protective case 500. FIG. 46 is a cross section taken along line 46-46 of FIG. 40, and FIG. 47 is a cross section taken along line 47-47 of FIG. 40.

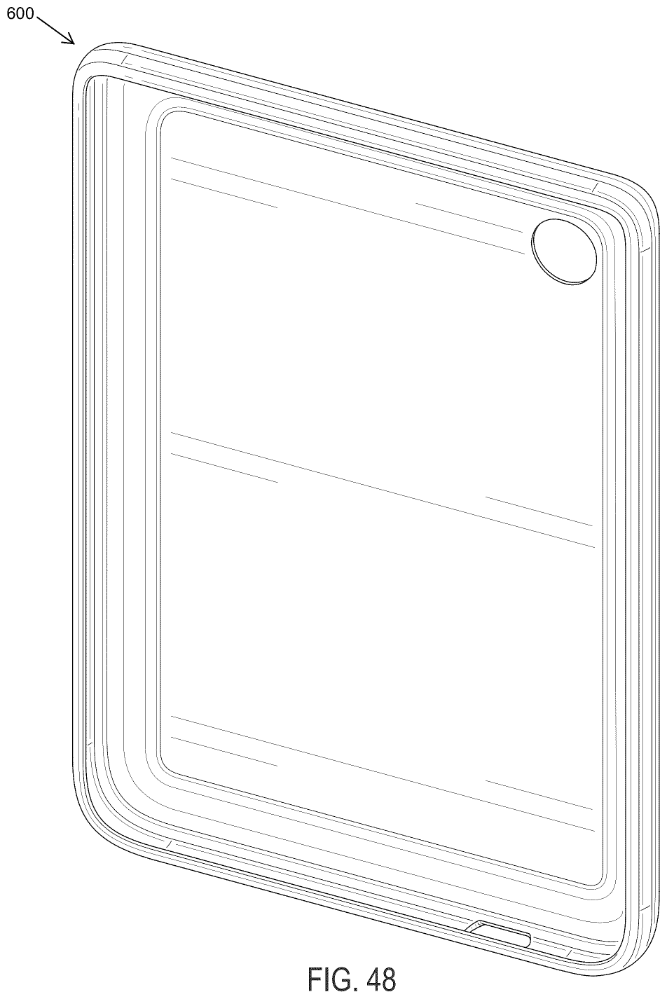

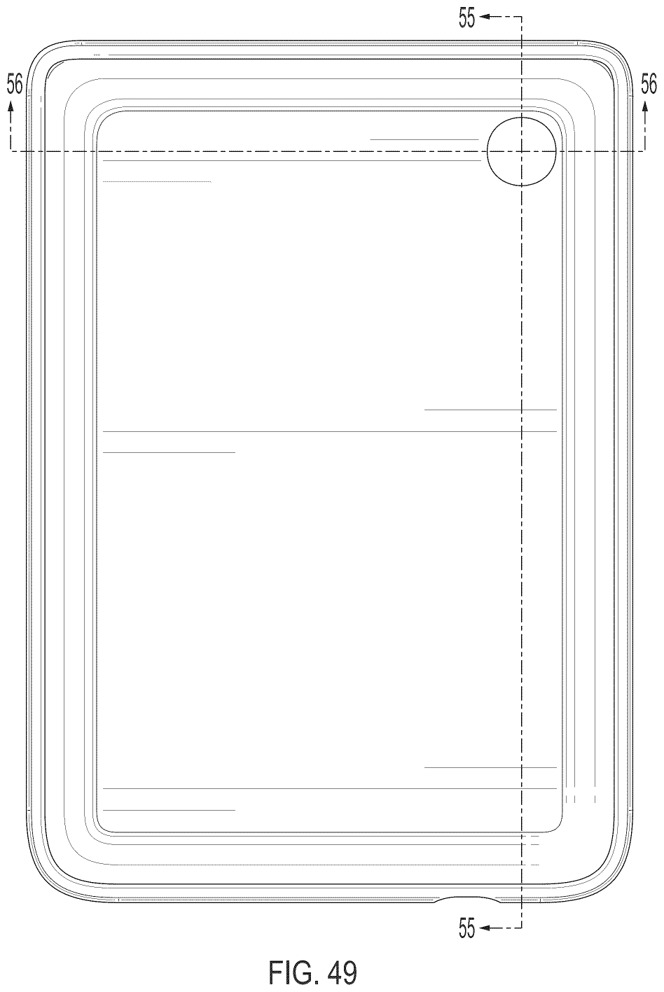

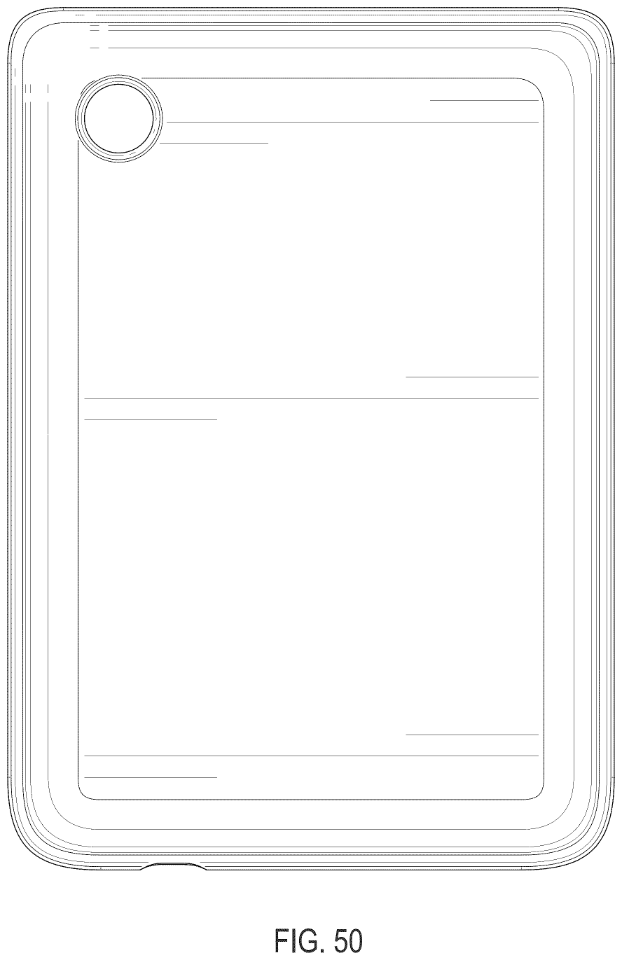

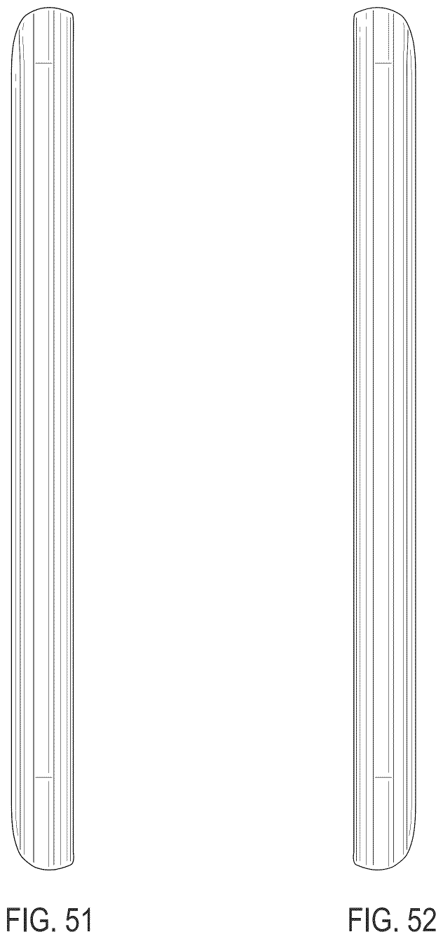

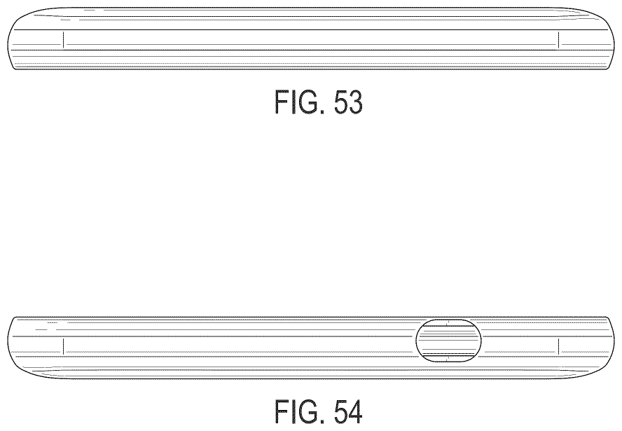

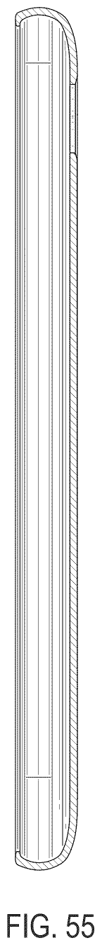

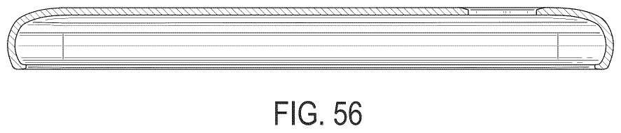

FIGS. 48-56 are diagrams of an example protective case 100, as described in more detail elsewhere herein. In some implementations, the protective case 100 may be configured to protect an electronic device. FIG. 48 is a front perspective view, FIG. 49 is a front plan view, FIG. 50 is a rear plan view, FIG. 51 is a left elevation view, FIG. 52 is a right elevation view, FIG. 53 is a top elevation view, and FIG. 54 is a bottom elevation view of the protective case 600. FIG. 55 is a cross section taken along line 55-55 of FIG. 49. FIG. 56 is a cross section taken along line 56-56 of FIG. 49.

In some implementations, one or more components described herein (e.g., one or more components of the protective cases 100, the protective case 200, the protective case 300, the protective case 400, the protective case 500, and/or the protective case 600) may be composed of one or more thermoplastic polymers, such as polycarbonate (PC), acrylonitrile butadiene styrene (ABS), polyethylene terephthalate glycol (PETG), and/or polymethyl methacrylate (PMMA), among other examples.

Additionally, or alternatively, one or more components described herein (e.g., one or more components of the protective cases 100, the protective case 200, the protective case 300, the protective case 400, the protective case 500, and/or the protective case 600) may be covered (e.g., wrapped, laminated, and/or coated) in one or more materials, such as synthetic leather (e.g., polyurethane (PU) leather, polyvinyl chloride (PVC) leather, microfiber leather, and/or silicone-based leather), among other examples.

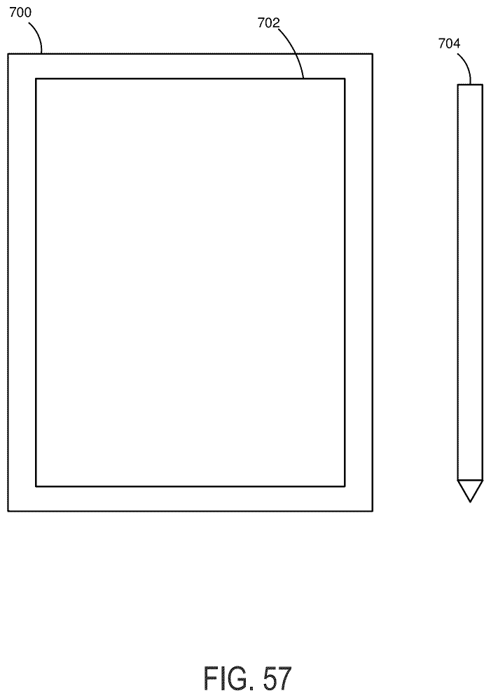

FIG. 57 is a diagram of an example electronic device 700 (e.g., including a display screen 702) and a stylus 704 associated with the electronic device 700. The electronic device 700 may include one or more devices capable of receiving, generating, storing, processing, and/or providing information (e.g., in association with presenting digital content for consumption). The electronic device 700 may include a communication device and/or a computing device. For example, the electronic device 700 may include a wireless communication device, a mobile phone, a user equipment, a laptop computer, a tablet computer, a desktop computer, a wearable communication device (e.g., a smart wristwatch, a pair of smart eyeglasses, a head mounted display, or a virtual reality headset), or a similar type of device.

In some implementations, the stylus 702 may include one or more components configured to interact with the electronic device 700, such as to facilitate user input, navigation, drawing, writing, and/or gesture control. The stylus 702 may include a passive or active input device, and may incorporate various features, such as pressure sensitivity, tilt detection, haptic feedback, and/or or wireless communication capabilities, among other examples. In some implementations, the protective case 100, the protective case 200, the protective case 300, the protective case 400, the protective case 500, and/or the protective case 600 may be configured to protect the electronic device 700 and/or the stylus 704, as described in more detail elsewhere herein.

The foregoing disclosure provides illustration and description, but is not intended to be exhaustive or to limit the implementations to the precise forms disclosed. Modifications may be made in light of the above disclosure or may be acquired from practice of the implementations.

Even though particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

In the preceding specification, various example embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

What is claimed is:

1. A protective case for an electronic device, comprising:
a front cover;
a rear cover including a first sidewall, a second sidewall aligned at an angle relative to the first sidewall, and a storage compartment positioned adjacent to the first sidewall,
wherein the second sidewall is configured to releasably retain the electronic device, and
wherein the storage compartment is configured to detachably store a stylus associated with the electronic device; and
a hinge, operatively connecting the front cover to the rear cover, defining a hinge axis,
wherein the front cover is movable, relative to the rear cover and about the hinge axis, between a closed position and an open position.

2. The protective case of claim 1, wherein the storage compartment includes a surface that transitions into the first sidewall.

3. The protective case of claim 1, wherein the first sidewall is a partial sidewall that defines a gap between the first sidewall and the second sidewall.

4. The protective case of claim 1, wherein the second sidewall includes a curved surface configured to conform to a contour of the electronic device.

5. The protective case of claim 1, further comprising:
magnets embedded in the first sidewall configured to align and interact with magnets embedded in the stylus to enable wireless charging of the stylus when the stylus is detachably stored.

6. The protective case of claim 1, wherein the front cover includes a fold line that divides the front cover into a first portion and a second portion and that defines a fold line axis about which the first portion is movable relative to the second portion.

7. The protective case of claim 6, wherein the first portion defines recesses configured to receive buttons of the electronic device.

8. The protective case of claim 1, wherein the first sidewall, the second sidewall, and the storage compartment are formed as a single molded component.

9. The protective case of claim 1, wherein the rear cover includes a curved peripheral edge portion.

10. The protective case of claim 1, wherein the second sidewall includes a tapered portion.

11. The protective case of claim 1, wherein the storage compartment is positioned between the hinge and the first sidewall when the front cover is in the open position.

12. The protective case of claim 1, wherein the hinge at least partially surrounds the storage compartment when the front cover is in the closed position.

13. A system, comprising:
an electronic device; and
a protective case, the protective case including:
a front cover;
a rear cover including a first sidewall, a second sidewall aligned at an angle relative to the first sidewall, and a storage compartment positioned adjacent to the first sidewall,
wherein the second sidewall is configured to releasably retain the electronic device, and
wherein the storage compartment is configured to detachably store a stylus associated with the electronic device; and
a hinge, operatively connecting the front cover to the rear cover, defining a hinge axis,
wherein the front cover is movable, relative to the rear cover and about the hinge axis, between a closed position and an open position.

14. The system of claim 13, wherein the storage compartment includes a surface that transitions into the first sidewall.

15. The system of claim 13, wherein the first sidewall is a partial sidewall that defines a gap between the first sidewall and the second sidewall.

16. The system of claim 13, wherein the second sidewall includes a curved surface configured to conform to a contour of the electronic device.

17. The system of claim 13, wherein the protective case includes magnets embedded in the first sidewall configured to align with and interact with magnets embedded in the stylus, enabling wireless charging of the stylus when the stylus is detachably stored.

18. The system of claim 13, wherein the storage compartment is positioned between the hinge and the first sidewall when the front cover is in the open position.

19. The system of claim 13, wherein the front cover includes a fold line that divides the front cover into a first portion and a second portion and that defines a fold line axis about which the first portion is movable relative to the second portion.

20. The system of claim 19, wherein the first portion defines recesses configured to receive buttons of the electronic device.
